(19) United States
(12) Patent Application Publication
(10) Pub. No.: US 2018/0124784 A1
(43) Pub. Date: May 3, 2018

(54) POWER EFFICIENT ANCHOR CARRIER SELECTION IN LTE ADVANCED

(71) Applicant: QUALCOMM Incorporated, San Diego, CA (US)

(72) Inventors: Akash Kumar, Hyderabad (IN); Ankit Maheshwari, Hyderabad (IN); Atul Soni, Hyderabad (IN); Pankaj Gupta, Hyderabad (IN); Pankaj Bansal, Jaipur (IN)

(21) Appl. No.: 15/340,185

(22) Filed: Nov. 1, 2016

(51) Int. Cl. H04W 72/04; H04W 52/02

(52) U.S. Cl. CPC H04W 72/0453; H04W 24/08; H04W 52/0206

(57) ABSTRACT

Methods, systems, and devices for wireless communication by a user equipment (UE) are described. A UE may be operating in a downlink carrier (DL) carrier aggregation (CA) mode, which may include a first component carrier and a second carrier component of a set of component carriers. The UE may determine the second component carrier satisfies throughput requirements associated with an uplink (UL) data transmission. The UE may determine, a transmission current consumption relationship between the first component carrier and the second component carrier. The UE may determine, based on the transmission current consumption relationship, whether to switch the anchor carrier from the first component carrier to the second component carrier. When the UE determined to switch the anchor carrier, the UE may modify a measurement report to satisfy a condition for switching the anchor carrier from the first component carrier to the second component carrier.

### BACKGROUND

### Field of the Disclosure

The present disclosure, for example, relates to wireless communication systems, and more particularly to selecting a power efficient anchor carrier.

### Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, (e.g., a Long Term Evolution (LTE) system). A wireless multiple access communications system may include a number of base stations, each simultaneously supporting communication for multiple communication devices, which may be otherwise known as user equipment (UE).

In an LTE or LTE-Advanced (LTE-A) network, a base station and a UE may communicate over dedicated frequency spectrum that is licensed to the network operator. A licensed operator network (e.g., cellular network, etc.) may be known as a public land mobile network (PLMN). With increasing data traffic in cellular networks, wireless communications systems may support carrier aggregation (CA) techniques that include communications using more than one carrier. The number of component carriers that are aggregated may be different in downlink (DL) and uplink (UL) communications. The component carriers may be arranged in a number of ways, for example, based on contiguous component carriers within the same operating frequency band and/or based on non-contiguous allocations, where the component carriers may be either intra-band or inter-band.

The CA configuration may be dynamically configured by a base station and may include assignment of an anchor carrier from the component carriers that form the aggregated carrier. Typically, an anchor carrier is used for both DL and UL communications with a UE. Improved methods of selecting the anchor carrier from the component carriers are desired.

### SUMMARY

The described techniques relate to improved methods, systems, devices, or apparatus that support selecting an anchor carrier for a carrier aggregation (CA) mode configuration. A downlink (DL) CA mode may include two or more component carriers from a base station (or multiple base stations or carrier devices) to a user equipment (UE) to form an aggregated carrier. A first component carrier may be initially designated as the anchor carrier, for example, a primary component carrier (PCC) served or provided by a primary cell (PCell). A second component carrier may be designated as a secondary component carrier (SCC) served or provided by a secondary cell (SCell). The DL CA mode may include additional component carriers that are also designated as SCCs (e.g., each of a third, fourth, and fifth component carrier may also be designated as SCCs served or provided by one or more SCells).

In some cases, the UE may determine that a second component carrier of the DL CA mode satisfies throughput requirements associated with an uplink (UL) data transmission. The UE may then determine a first transmit power level associated with the first component carrier and may estimate a second transmit power level associated with the second component carrier. Based at least in part on these transmit power levels, the UE may determine a transmission current consumption relationship. The transmission current consumption relationship may include current consumption requirements associated with UL data transmission on the first component carrier and the second component carrier.

The transmission current consumption relationship may include explicit current consumption information (e.g., measured data from actual or factory test mode UL transmissions). In some cases, the transmission current consumption relationship may include inherent or inferred current consumption information (e.g., current consumption expectations due to the bandwidth of the first and second component carriers or a temperature change associated with one component carrier, but not the other component carrier). The UE may then determine whether to switch the anchor carrier from the first component carrier to the second component carrier in the DL CA mode. For example, when the UE determines that current consumption may be reduced (and thereby battery power may be conserved), the UE may determine to switch the anchor carrier from the first component carrier to the second component carrier.

The UE may communicate this switch to the base station for reconfiguration of the DL CA mode. For example, the UE may modify a measurement report (e.g., an A5 measurement report for providing handover to a lower priority carrier) to satisfy a condition for switching the anchor carrier from the first component carrier to the second component carrier in the DL CA mode. The UE may transmit the modified measurement report to the base station so that the base station may reconfigure the DL CA mode and transmit the reconfiguration instruction to the UE as well as to any other network components responsible for component carrier transmission.

A method of wireless communication by a UE is described. The method may include determining a second component carrier of a plurality of component carriers in a DL CA mode satisfies throughput requirements associated with an UL data transmission, determining, based at least in part on the throughput requirements being satisfied, a first transmit power level associated with a first component carrier of the plurality of component carriers, the first component carrier being an anchor carrier for the plurality of component carriers in the DL CA mode, estimating a second transmit power level associated with the second component carrier, determining, based at least in part on the first transmit power level and the second transmit power level, a transmission current consumption relationship, and determining, based at least in part on the transmission current consumption relationship, whether to switch the anchor carrier from the first component carrier to the second component carrier in the DL CA mode.

An apparatus for wireless communication is described. The apparatus may include a processor, memory in electronic communication with the processor, and one or more instructions stored in the memory. The one or more instructions may be operable to cause the apparatus to determine a second component carrier of a plurality of component carriers in a DL CA mode satisfies throughput requirements associated with an UL data transmission, determine, based at least in part on the throughput requirements being satisfied, a first transmit power level associated with a first component carrier of the plurality of component carriers, the first component carrier being an anchor carrier for the plurality of component carriers in the DL CA mode, estimate a second transmit power level associated with the second component carrier, determine, based at least in part on the first transmit power level and the second transmit power level, a transmission current consumption relationship, and determine, based at least in part on the transmission current consumption relationship, whether to switch the anchor carrier from the first component carrier to the second component carrier in the DL CA mode.

Another apparatus for wireless communication is described. The apparatus may include means for determining a second component carrier of a plurality of component carriers in a DL CA mode satisfies throughput requirements associated with an UL data transmission, means for determining, based at least in part on the throughput requirements being satisfied, a first transmit power level associated with a first component carrier of the plurality of component carriers, the first component carrier being an anchor carrier for the plurality of component carriers in the DL CA mode, means for estimating a second transmit power level associated with the second component carrier, means for determining, based at least in part on the first transmit power level and the second transmit power level, a transmission current consumption relationship, and means for determining, based at least in part on the transmission current consumption relationship, whether to switch the anchor carrier from the first component carrier to the second component carrier in the DL CA mode.

A non-transitory computer readable medium for wireless communication is described. The non-transitory computer-readable medium may include one or more instructions operable to cause a processor to determine a second component carrier of a plurality of component carriers in a DL CA mode satisfies throughput requirements associated with an UL data transmission, determine, based at least in part on the throughput requirements being satisfied, a first transmit power level associated with a first component carrier of the plurality of component carriers, the first component carrier being an anchor carrier for the plurality of component carriers in the DL CA mode, estimate a second transmit power level associated with the second component carrier, determine, based at least in part on the first transmit power level and the second transmit power level, a transmission current consumption relationship, and determine, based at least in part on the transmission current consumption relationship, whether to switch the anchor carrier from the first component carrier to the second component carrier in the DL CA mode.

Some examples of the method, apparatus, and non-transitory computer-readable medium described above may further include processes, features, means, or instructions for determining to switch the anchor carrier from the first component carrier to the second component carrier based at least in part on a bandwidth of the first component carrier being larger than a bandwidth of the second component carrier.

Some examples of the method, apparatus, and non-transitory computer-readable medium described above may further include processes, features, means, or instructions for identifying that the first component carrier corresponds to a first transmit chain and the second component carrier corresponds to a second transmit chain different from the first transmit chain. In some examples, the determining of whether to switch the anchor carrier from the first component carrier to the second component carrier is further based at least in part on a temperature change associated with one or more components of the first transmit chain. Some examples of the method, apparatus, and non-transitory computer-readable medium described above may further include processes, features, means, or instructions for determining to switch the anchor carrier from the first component carrier to the second component carrier based at least in part on the temperature change associated with one or more components of the first transmit chain satisfying a transmission performance decrease threshold.

In some examples of the method, apparatus, and non-transitory computer-readable medium described above, the estimating the second transmit power level associated with the second component carrier comprises estimating a power level required for UL transmission on a carrier frequency band of the second component carrier.

In some examples of the method, apparatus, and non-transitory computer-readable medium described above, the estimating the second transmit power level associated with the second component carrier comprises estimating the second transmit power level associated with the second component carrier based at least in part on a receive power associated with the second component carrier in the DL CA mode.

In some examples of the method, apparatus, and non-transitory computer-readable medium described above, the determining the transmission current consumption relationship comprises comparing a transmission current value associated with the first transmit power level and an estimated transmission current value associated with the second transmit power level. In some examples, the transmission current value associated with the first transmit power level is an estimated transmission current value associated with the first transmit power level.

In some examples of the method, apparatus, and non-transitory computer-readable medium described above, the determining the transmission current consumption relationship comprises referencing a transmission current estimation look-up table (LUT), the transmission current estimation LUT including a plurality of power amplifier current consumption values, each power amplifier current consumption value associated with at least one of a transmit power level and a carrier frequency band or an UL transmission bandwidth.

In some examples of the method, apparatus, and non-transitory computer-readable medium described above, the determining the transmission current consumption relationship comprises determining a hysteresis parameter for satisfying a performance increase threshold.

Some examples of the method, apparatus, and non-transitory computer-readable medium described above may further include processes, features, means, or instructions for determining throughput requirements associated with an UL data transmission based at least in part on an application executed by the UE.

An additional method of wireless communication by a UE is described. The method may include determining a first transmit power level associated with a first component carrier of a plurality of component carriers, the first component carrier being an anchor carrier for the plurality of component carriers in a DL CA mode, estimating a second transmit power level associated with a second component carrier of the plurality of component carriers, determining, based at least in part on the first transmit power level and the second transmit power level, a transmission current consumption relationship in the DL CA mode, determining, based at least in part on the determining the transmission current consumption relationship, to switch the anchor carrier from the first component carrier to the second component carrier in the DL CA mode, and modifying a measurement report, based at least in part on the determining to switch the anchor carrier, to satisfy a condition for switching the anchor carrier from the first component carrier to the second component carrier in the DL CA mode.

An apparatus for wireless communication is described. The apparatus may include a processor, memory in electronic communication with the processor, and one or more instructions stored in the memory. The one or more instructions may be operable to cause the apparatus to determine a first transmit power level associated with a first component carrier of a plurality of component carriers, the first component carrier being an anchor carrier for the plurality of component carriers in a DL CA mode, estimate a second transmit power level associated with a second component carrier of the plurality of component carriers, determine, based at least in part on the first transmit power level and the second transmit power level, a transmission current consumption relationship in the DL CA mode, determine, based at least in part on the determining the transmission current consumption relationship, to switch the anchor carrier from the first component carrier to the second component carrier in the DL CA mode, and modify a measurement report, based at least in part on the determining to switch the anchor carrier, to satisfy a condition for switching the anchor carrier from the first component carrier to the second component carrier in the DL CA mode.

Another apparatus for wireless communication is described. The apparatus may include means for determining a first transmit power level associated with a first component carrier of a plurality of component carriers, the first component carrier being an anchor carrier for the plurality of component carriers in a DL CA mode, means for estimating a second transmit power level associated with a second component carrier of the plurality of component carriers, means for determining, based at least in part on the first transmit power level and the second transmit power level, a transmission current consumption relationship in the DL CA mode, means for determining, based at least in part on the determining the transmission current consumption relationship, to switch the anchor carrier from the first component carrier to the second component carrier in the DL CA mode, and means for modifying a measurement report, based at least in part on the determining to switch the anchor carrier, to satisfy a condition for switching the anchor carrier from the first component carrier to the second component carrier in the DL CA mode.

A non-transitory computer readable medium for wireless communication is described. The non-transitory computer-readable medium may include one or more instructions operable to cause a processor to determine a first transmit power level associated with a first component carrier of a plurality of component carriers, the first component carrier being an anchor carrier for the plurality of component carriers in a DL CA mode, estimate a second transmit power level associated with a second component carrier of the plurality of component carriers, determine, based at least in part on the first transmit power level and the second transmit power level, a transmission current consumption relationship in the DL CA mode, determine, based at least in part on the determining the transmission current consumption relationship, to switch the anchor carrier from the first component carrier to the second component carrier in the DL CA mode, and modify a measurement report, based at least in part on the determining to switch the anchor carrier, to satisfy a condition for switching the anchor carrier from the first component carrier to the second component carrier in the DL CA mode.

In some examples of the method, apparatus, and non-transitory computer-readable medium described above, the modifying the measurement report, based at least in part on the determining to switch the anchor carrier, to satisfy a condition for switching the anchor carrier comprises modifying the measurement report, based at least in part on the determining to switch the anchor carrier, to interchange the first component carrier and the second component carrier in the DL CA mode.

In some examples of the method, apparatus, and non-transitory computer-readable medium described above, the modifying the measurement report comprises modifying an A5 measurement report such that a received power metric associated with one of the first component carrier or the second component carrier is altered.

Some examples of the method, apparatus, and non-transitory computer-readable medium described above may further include processes, features, means, or instructions for transmitting the measurement report to a base station.

Some examples of the method, apparatus, and non-transitory computer-readable medium described above may further include processes, features, means, or instructions for transmitting an indication that the measurement report has been modified to a base station.

In some examples of the method, apparatus, and non-transitory computer-readable medium described above, a carrier frequency band of the first component carrier is a Long Term Evolution-Advanced (LTE-A) radio frequency spectrum band.

In some examples of the method, apparatus, and non-transitory computer-readable medium described above, a carrier frequency band of the second component carrier is an unlicensed radio frequency spectrum band.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a system for wireless communication that supports selecting an anchor carrier in accordance with aspects of the present disclosure.

FIGS. 2A and 2B illustrate examples of downlink (DL) carrier aggregation (CA) mode in which anchor carrier selection techniques are performed in accordance with aspects of the present disclosure.

FIG. 3 illustrates an example of wireless transceiver components of a user equipment (UE) that can be used for anchor carrier selection in accordance with aspects of the present disclosure.

FIG. 4 illustrates an example of a transceiver current to transmit power plot that can be used for determining a transmission current consumption relationship in accordance with aspects of the present disclosure.

FIG. 5 illustrates an example of a power amplifier current to transmit power plot that can be used for determining a transmission current consumption relationship in accordance with aspects of the present disclosure.

FIG. 6 illustrates an example of a process flow that supports UE anchor carrier selection in accordance with aspects of the present disclosure.

FIGS. 7 through 9 show block diagrams of a device that supports selecting a power efficient anchor carrier in accordance with aspects of the present disclosure.

FIG. 10 illustrates a block diagram of a system including a UE that supports selecting a power efficient anchor carrier in accordance with aspects of the present disclosure.

FIGS. 11 through 14 illustrate methods for selecting a power efficient anchor carrier in accordance with aspects of the present disclosure.

### DETAILED DESCRIPTION

User equipment (UE) capabilities and data throughput demands and requirements continue to increase (e.g., gaming and data intensive applications). Carrier aggregation (CA) techniques may be used by a UE in a wireless network that include communications using more than one carrier. For example, 3rd Generation Partnership Project (3GPP) Long Term Evolution (LTE) Advanced (LTE-A) systems support multiple forms of CA to provide increased data throughput demands. Generally, CA provides high data throughput to the UE, but can be inefficient in terms of power usage (e.g., current consumption) at the UE. For example, during downlink (DL) CA operations, the uplink (UL) transmission occurs on the anchor carrier (e.g., the primary carrier component (PCC)) while the DL reception occurs on both the anchor carrier and one or more additional component carriers that form an aggregated carrier to the UE. In the DL CA mode, it may be beneficial to select an appropriate carrier as the anchor carrier to reduce the current consumption associated with UL transmission in a DL CA communication.

It is, however, to be appreciated that the current consumed by a UE may or may not be a significant consideration to the power management of the UE depending on the particular situation or condition of the UE. For example, when a UE is at (or near) full battery power and/or is receiving power from an external power source (e.g., recharging the battery of the UE), the transmission current consumption for UL transmission required for any given component carrier in a DL CA mode may not be a significant factor. If, however, the UE is low on remaining battery power, the transmission current consumption for UL transmission in the DL CA mode may become a significant factor in preserving the remaining battery power. Moreover, because anchor carrier selection is generally within the purview of the base station, the UE may need to modify a measurement report (e.g., spoof a known measurement report so as to force the base station to implement the desired change to a more power efficient anchor carrier) in order to select a power efficient anchor carrier.

Techniques for selecting an anchor carrier by a UE are described in which transmission current consumption relationships associated with the DL CA mode are determined to ascertain a power efficient anchor carrier among the available component carriers. Techniques for communicating the selected power efficient anchor carrier from the UE to the base station are also described.

Aspects of the disclosure are initially described in the context of a wireless communications system. Non-limiting examples of switching an anchor carrier in a DL CA mode are then provided. Aspects of the disclosure are further illustrated by and described with reference to apparatus diagrams, transmission current relationship plots, system diagrams, and flowcharts that relate to selection of a power efficient anchor carrier.

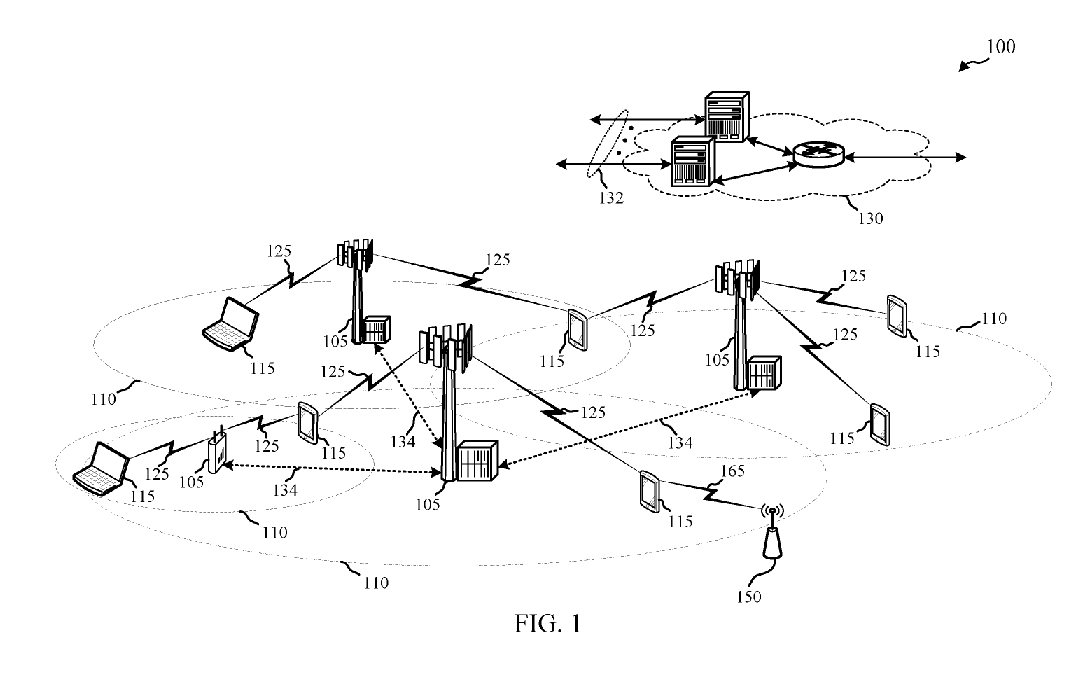

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be an LTE (e.g., or an LTE-Advanced) network. The wireless communications system 100 may support various aspects of the anchor carrier selection techniques described herein.

Base stations 105 may wirelessly communicate with UEs 115 (e.g., using various RATs or wireless technologies) via one or more base station antennas. Each base station 105 may provide communication coverage for a respective geographic coverage area 110. Communication links 125 shown in wireless communications system 100 may include UL transmissions from a UE 115 to a base station 105, or DL transmissions, from a base station 105 to a UE 115. UEs 115 may be dispersed throughout the wireless communications system 100, and each UE 115 may be stationary or mobile. A UE 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may also be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of things (IoT) device, an Internet of Everything (IoE) device, a machine type communication (MTC) device, an appliance, an automobile, or the like.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105. In some examples, base stations 105 may be macro cells, small cells, hot spots, or the like. A base station 105 may also be referred to as an access point (“AP”), a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

Wireless communication system 100 may include a packet-based network that operates according to a layered protocol stack where data in the user plane may be based on the internet protocol (IP). A radio link control (RLC) layer may perform packet segmentation and reassembly to communicate over logical channels. A medium access control (MAC) layer may perform priority handling and multiplexing of logical channels into transport channels. The MAC layer may also use hybrid automatic repeat request (HARQ) to provide retransmission at the MAC layer to improve link efficiency. In the control plane, the radio resource control (RRC) protocol layer may provide establishment, configuration, and maintenance of an RRC connection between a UE 115 and the base stations 105. The RRC protocol layer may also be used for core network 130 support of radio bearers for the user plane data. The RRC protocol layer may handle the Layer 3 control plane signaling by which a network (e.g., an evolved universal terrestrial access network (E-UTRAN)) controls the UE behavior.

The RRC protocol may cover a number of functional areas including system information (SI) broadcasting, connection control including handover within LTE, network-controlled inter-RAT mobility and measurement configuration and reporting. At the physical (PHY) layer, the transport channels may be mapped to physical channels.

In some examples, the wireless communications system 100 is an LTE/LTE-Advanced (LTE-A) network. In LTE/LTE-A networks, the term evolved node B (eNB) may be generally used to describe the base stations 105, while the term UE may be generally used to describe the UEs 115. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with various types of base stations 105 and network equipment including, but not limited to, macro eNBs, small cell eNBs, relay base stations, and the like. The wireless communications system 100 may be a heterogeneous LTE/LTE-A network in which different types of eNBs provide coverage for various geographical regions. For example, each eNB or base station 105 may provide communication coverage for a macro cell, a small cell, or other types of cell. The term “cell” can be used to describe a base station, a carrier or component carrier associated with a base station, or a coverage area (e.g., sector, etc.) of a carrier or base station, depending on context.

Wireless communications system 100 may support operation on multiple cells or carriers, a feature which may be referred to as CA or multi-carrier operation. A carrier may also be referred to as a component carrier, a layer, a channel, etc. The term “component carrier” may refer to each of the multiple carriers utilized by a UE in CA operation, and may be distinct from other portions of system bandwidth. For instance, a component carrier may be a relatively narrow-bandwidth carrier susceptible of being utilized independently or in combination with other component carriers. Each component carrier may provide the same (or similar) capabilities as an isolated carrier based on Release 8 or Release 9 of the Long Term Evolution (LTE) standard. Multiple component carriers may be aggregated or utilized concurrently to provide some UEs 115 with greater bandwidth and, for example, higher data throughput rates. Thus, individual component carriers may be backwards compatible with legacy UEs 115 (e.g., UEs 115 implementing LTE release 8 or release 9); while other UEs 115 (e.g., UEs 115 implementing post-Release 8/9 LTE versions), may be configured with multiple component carriers in a multi-carrier mode.

Each component carrier may be used to transmit control information (e.g., reference signals, control channels, etc.), overhead information, data, etc. A UE 115 may communicate with a single base station 105 utilizing multiple carriers, and may also communicate with multiple base stations simultaneously on different carriers. DL CA may be used with both frequency division duplexing (FDD) and time division duplexing (TDD) component carriers. Each serving cell of a base station 105 may include a component carrier that may be a DL component carrier or a TDD component carrier. A serving cell may include an UL component carrier in FDD operation. The coverage area 110 of each serving cell for a base station 105 may be different (e.g., component carriers on different frequency bands may experience different path loss).

In some examples, one component carrier is designated as the anchor carrier or primary component carrier (PCC), for a UE 115, which may be served by a primary cell (PCell). PCells may be semi-statically configured by higher layers (e.g., RRC, etc.) on a per-UE basis. Certain uplink control information (UCI), e.g., acknowledgement (ACK)/negative-acknowledgement (NACK), channel quality indicator (CQI), and scheduling information transmitted on physical uplink control channel (PUCCH), are carried by the PCell. Additional component carriers may be designated as secondary component carriers (SCCs), which may be served by secondary cells (SCells). SCells may likewise be semi-statically configured on a per-UE basis. In some cases, SCells may not include or be configured to transmit the same (or similar) control information as the PCell.

In some DL CA mode examples, multiple component carriers may be simultaneously used for the DL communication, whereas the anchor carrier or PCC, which may be served by a PCell, is typically the only component carrier used for UL communication. In some cases, additional component carriers may be used for UL communication, but the anchor carrier or PCC remains a component carrier for UL communication. In some examples, the number of component carriers that form an aggregated carrier in the DL CA mode is five.

Additionally, some wireless networks may utilize enhanced CA operations based on a large number of component carriers (e.g., between 5 and 32 carriers), operation in shared spectrum, or use of enhanced component carriers. For example, a UE 115 may be configured for DL CA using a PCell in dedicated spectrum (e.g., licensed radio frequency bands), one or more SCells in dedicated spectrum, and one or more SCells in unlicensed spectrum (e.g., radio frequency bands available for use without a license, but are typically subject to technical rules regarding access and transmitted power) or shared spectrum (e.g., radio frequency bands licensed to one or more operators, but are typically subject to some device coexistence procedures). By way of example, FIG. 1 shows a network comprised of a Wireless Fidelity (Wi-Fi) access point (AP) 150 in communication with a UE 115 via Wi-Fi communication link 165 in shared spectrum.

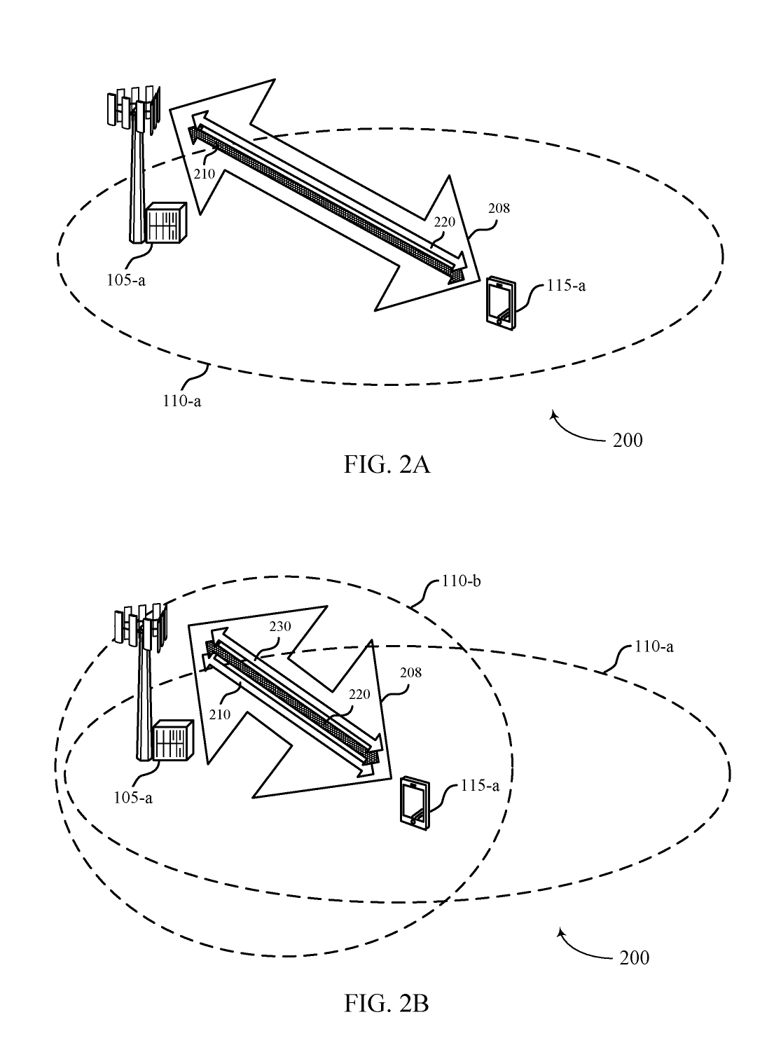

UE(s) 115 and base station(s) 105 of wireless communications system 100 may support improved anchor carrier selection techniques, such as is described with reference to FIGS. 2A through 6.

FIGS. 2A and 2B illustrate examples of a DL CA mode in which anchor carrier selection techniques are performed in accordance with aspects of the present disclosure. UE 115-a and base station 105-a may be examples of aspects of a UE 115 and a base station 105 as described with reference to FIG. 1. UE 115-a and base station 105-a may operate in wireless communications environment 200, which may correspond, for example, to one or more aspects of wireless communication system 100 of FIG. 1. The described techniques are discussed for cells operating in dedicated spectrum using LTE-A communications in a DL CA mode. However, it is to be understood that the described techniques are applicable to other spectrum environments, for example, where a combination of dedicated, unlicensed, and/or shared spectrum may be utilized for component carriers in DL CA and other CA modes and operations.

As illustrated in the example of FIG. 2A, UE 115-a may be in communication with base station 105-a and may be configured by base station 105-a for DL CA mode. An aggregate carrier 208 may include a first component carrier 210 that is designated as the anchor carrier (shaded in FIG. 2A) and a second component carrier 220. The first component carrier 210, being designated as the anchor carrier or PCC, may be served by a PCell of base station 105-a using the dedicated spectrum. The second component carrier 220 may be an SCC and may be served by an SCell using the dedicated spectrum. The serving cell or cells for base station 105-a that provide the first component carrier 210 and the second component carrier 220 may have a coverage area 110-a that is different from other serving cells for base station 105-a. Each of the first carrier component 110 and the second carrier component 120 can have a bandwidth of 1.4, 3, 5, 10, 15 or 20 MHz, for example.

UE 115-a may trigger an anchor carrier switch (or at least trigger determining whether to switch to a different anchor carrier) based on various factors and considerations described herein. Various processes and mechanisms may be utilized by the UE 115 to select an anchor carrier (or request reselection of the anchor carrier) to improve or optimize battery usage while achieving the same data throughput (or comparable data throughput within a range) as an initial anchor carrier designation and DL CA mode configuration provided by the base station 105-a. In aspects, the anchor carrier selection techniques and apparatus described herein may be useful to improve UE power consumption in prevalent scenarios where UL data requirements are low and/or consistent, without adversely affecting DL throughput.

For example, the UE 115-a may be triggered to determine whether to switch to a different anchor carrier based at least in part on the addition of a component carrier to the aggregated carrier 208. As illustrated in the example of FIG. 2B, UE 115-a may be mobile and may enter a short-range coverage area 110-b for an SCell of base station 105-a. The base station 105-a may provide a reconfiguration of the DL CA mode for UE 115-a such that the aggregated carrier includes a third component carrier 230. Based at least in part on this reconfiguration event, the UE 115-a may determine whether a more power efficient component carrier than the first component carrier 210 can be used as the anchor carrier for the aggregate carrier 208.

In this regard, the UE 115-a may determine a transmission current consumption relationship that can be used to determine a more power efficient anchor carrier. In some examples, a bandwidth of the first component carrier 210, the second component carrier 220, and the third component carrier 230 may be compared. Additionally or alternatively, the UE 115-a may detect a temperature change associated with one or more components of a respective transmit chain corresponding to the first component carrier 210, the second component carrier 220, and the third component carrier 230 (e.g., depending on which component carrier is presently designated as the anchor carrier). In some examples, a transmission current consumption look-up table (LUT) is utilized to select the appropriate anchor carrier. The transmission current consumption LUT may provide a current consumption value for a particular radio frequency band and transmit power, for example. During communications in the DL CA mode, the UE 115-a may utilize the transmission current consumption LUT to identify the current consumption value for any of the available component carriers that may be used as the anchor carrier (e.g., or PCC). In this manner, the transmission current consumption LUT can be used to estimate which of the available component carriers would provide power efficient UL transmission for the aggregate carrier 208.

The UE 115-a may determine that the second component carrier 220 has sufficient bandwidth to support UL communication (e.g., transmission) associated with an application (or group of applications) being executed by the UE 115-a in connection with the DL CA mode. The UE 115-a may rule out third component carrier 230 as a potential anchor carrier, for example, because third component carrier 230 has insufficient bandwidth to support UL communication (e.g., transmission) of because the SCell that provides the third component carrier 230 is not capable of performing functions required of a PCell.

In determining the transmission current consumption relationship between the first component carrier 210 and the second component carrier 220, the UE 115-a may consider the respective bandwidths of the first component carrier 210 and the second component carrier 220. For example, the first component carrier 210 may have a 20 MHz channel bandwidth and the second component carrier 220 may have a 10 MHz channel bandwidth. UE 115-a may determine based at least in part on the bandwidth difference and the corresponding radio frequency bands of the first component carrier 210 and the second component carrier 220 that a switch should be initiated to make the second component carrier 220 the anchor carrier or the PCC and the first component carrier 210 an SCC. For example, the UE 115-a may determine that the first component carrier 210 and the second component carrier 220 are contiguous intra-band component carriers. The UE 115-a may further determine that the transceiver current for communication (e.g., transmission) operations of the first component carrier 210 having a 20 Mhz channel bandwidth and FDD duplexing for a transmit power of 0 dBm and a transmission rate according to a modulation and coding scheme (MCS) of 12 is approximately 312 mA, and that the transceiver current for communication (e.g., transmission) operations of the second component carrier 220 having a 10 Mhz channel bandwidth and FDD duplexing for a transmit power of 0 dBm and a transmission rate according to an MCS of 12 is approximately 248 mA. Thus, the UE 115-a may determine that the power efficiency savings are sufficient to switch the anchor carrier from the first component carrier 210 to the second component carrier 220 (e.g., based at least in part on the channel bandwidths of the respective component carriers).

The UE 115-a may communicate the switch of the anchor carrier to the base station 105-a. In some examples, the UE 115-a may modify a measurement report to satisfy a condition for switching the anchor carrier from the first component carrier 210 to the second component carrier 220. In one non-limiting measurement report modification example, the UE 115-a may alter an A5 measurement report such that a received power metric associated with one of the first component carrier 210 or the second component carrier 220 is altered (e.g., a delta Δ may added to the to the reference signal received power (RSRP) of the second component carrier 220 to force a PCell switch from the first component carrier 210 to the component carrier 220). The UE 115-a may transmit the altered A5 measurement report to the base station 105-a, and the cellular network (including and/or in conjunction with the base station 105-a) of wireless communications environment 200 will trigger a handover interchanging the PCell associated with first component carrier 210 and the SCell associated with second component carrier 220.

The aggregate carrier 208 of wireless communications environment 200 may include the first component carrier 210 as an SCC, the second component carrier 220 that is now designated as the anchor carrier (shaded in FIG. 2B), and the third component carrier 230 as another SCC. Other anchor carrier switch examples similar to the example of FIGS. 2A and 2B are contemplated as disclosed herein and as would be apparent to one skilled in the art given the benefit of the present disclosure.

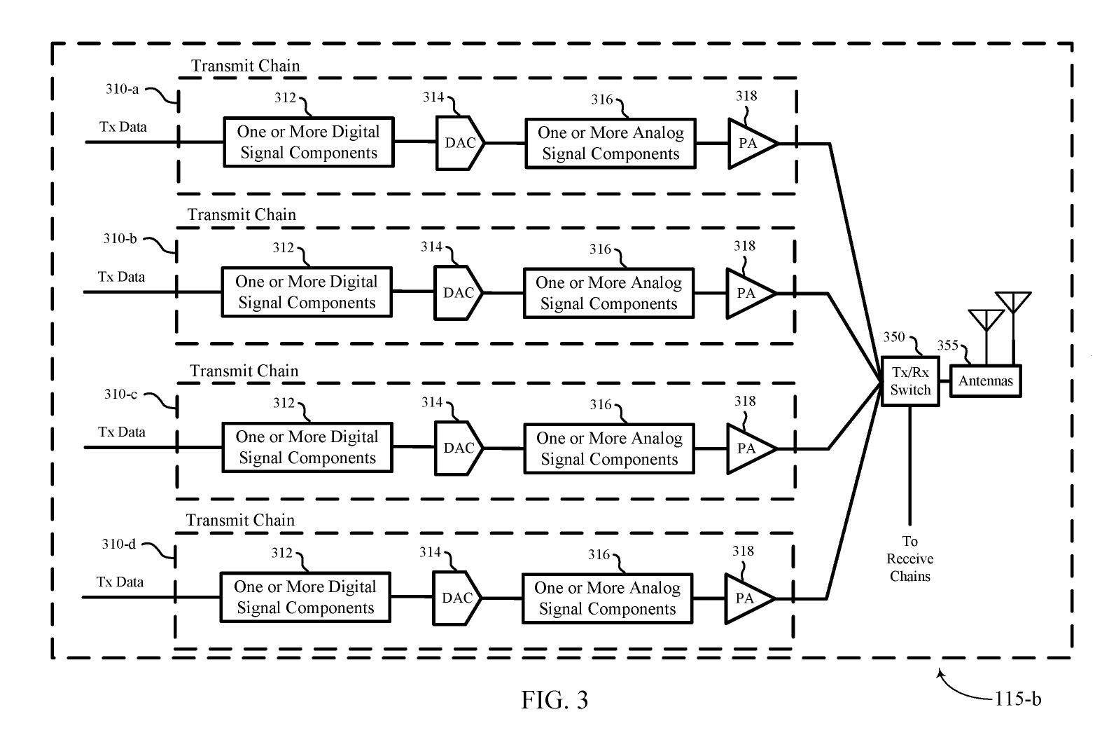

FIG. 3 illustrates an example of wireless transceiver components of a UE 115-b that can be used for anchor carrier selection in accordance with aspects of the present disclosure. UE 115-b may be an example of aspects of a UE 115 as described with reference to FIGS. 1, 2A, and 2B.

The UE115-b may include transmit chains 310-a, 310-b, 310-c, and 310-d. Each of transmit chain 310-a, 310-b, 310-c, and 310-d may be configured to operate in different radio frequency bands. For example, transmit chains 310-a, 310-b, and 310-c may be configured to operate on LTE/LTE-A radio frequency bands and transmit chain 310-d may be configured to operate on Wi-Fi or unlicensed radio frequency bands. In some cases, one or more of transmit chains 310-a, 310-b, and 310-c may be configured to operate on a particular set of LTE/LTE-A radio frequency bands (e.g., LTE bands 1, 4, and 17). In other cases, one or more of transmit chains 310-a, 310-b, and 310-c may be configured to operate on all LTE/LTE-A radio frequency bands (e.g., all LTE bands from 700 MHz to 2700 MHz).

Each of transmit chains 310-a, 310-b, 310-c, and 310-d may receive transmit data from other components of the UE 115-b. The transmit data may be provided to one or more digital signal components 312 for performing various functions associated with the digital domain such as, but not limited to, transmit finite impulse response (FIR) filtering, digital signal processing, current or voltage scaling, and digital predistortion processing. The output of the one or more digital signal components 312 may be provided to a digital-to-analog converter (DAC) 314. DAC 314 may convert filtered and processed digital signals of the transmit data to generate an analog signal.

The analog signal for each of transmit chains 310-a, 310-b, 310-c, and 310-d may be provided to one or more analog signal components 316 for performing various functions associated with the analog domain such as, but not limited to, baseband filtering (e.g., low-pass, high-pass, and/or bandpass filtering), signal conversion, and signal mixing. The transmit signal may then be amplified by power amplifier 318 and passed to a transmit-receive switcher 350. The transmit-receive switch 350 may then pass the transmit signal to one or more antennas 355 for communication (e.g., transmission) to a base station or another receiving wireless device. The transmit-receive switcher 350 also pass receive signals from the one or more antennas 355 to one or more receive chains (not shown) of the UE 115-b.

Accordingly, each of the one or more of transmit chains 310-a, 310-b, 310-c, and 310-d may. The UE 115-b may include one or more temperatures sensor located proximal to one or more of the components (e.g., power amplifier 318) of the one or more of transmit chains 310-a, 310-b, 310-c, and 310-d. In this manner, the UE 115-b can measure a temperature associated with a first transmit chain (e.g., transmit chain 310-a) and/or a temperature associated with a second transmit chain (e.g., one of transmit chains 310-b, 310-c, and 310-d).

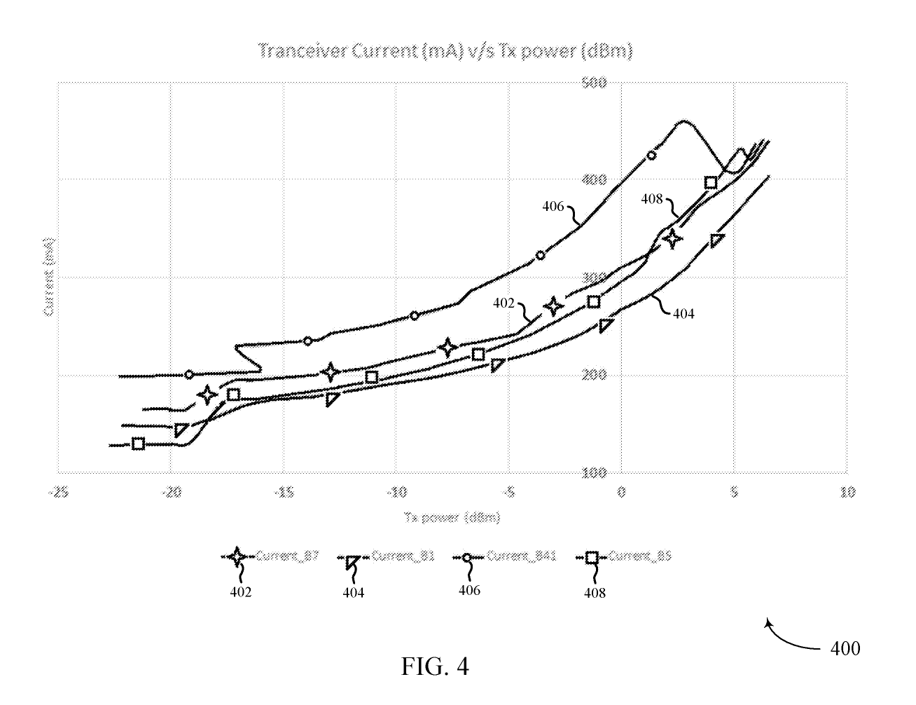

FIG. 4 illustrates an example of a transceiver current to transmit power plot 400 that can be used for determining a transmission current consumption relationship in accordance with aspects of the present disclosure. The example information associated with the transceiver current to transmit power plot 400 may be used by a UE 115 as described with reference to FIGS. 1 through 3. For example, the transceiver current to transmit power plot 400, similar information plots, and transmit current to power characteristics derived therefrom can be used for determining a transmission current consumption relationship between one or more component carriers of a UE 115. It is to be understood that the specific numerical values for transceiver current (mA) and transmit power (dBm) are examples for illustration purposes only, and therefore aspects and features associated with transmission current consumption relationships described herein are not limited to FIG. 4.

Plot line 402 corresponds to the transceiver current to transmit power characteristics of a transceiver (e.g., a transceiver associated with one of one or more of transmit chains 310-a, 310-b, 310-c, and 310-d of FIG. 3) operating in LTE band 7. Plot line 404 corresponds to the transceiver current to transmit power characteristics of a transceiver (e.g., a transceiver associated with one of one or more of transmit chains 310-a, 310-b, 310-c, and 310-d of FIG. 3) operating in LTE band 1. Plot line 406 corresponds to the transceiver current to transmit power characteristics of a transceiver (e.g., a transceiver associated with one of one or more of transmit chains 310-a, 310-b, 310-c, and 310-d of FIG. 3) operating in LTE band 41. Plot line 402 corresponds to the transceiver current to transmit power characteristics of a transceiver (e.g., a transceiver associated with one of one or more of transmit chains 310-a, 310-b, 310-c, and 310-d of FIG. 3) operating in LTE band 5.

In one example of a transmission current consumption relationship, a UE 115 may have a first component carrier in a DL CA mode that is operating on LTE band 5 and a second component carrier in the DL CA mode operating on LTE band 41. The first component carrier may be designated as the anchor carrier (e.g., or PCC) and may be transiting at a transmit power of 0 dBm. The UE 115 may estimate that a transceiver current associated with UL communication (e.g., transmission) on the first component carrier (utilizing LTE band 5) is approximately 300 mA. The second component carrier may be designated as an SCC and may have a received power metric such that the UE 115 may estimate that, if the second component carrier were selected as the anchor carrier (e.g., or PCC), the second component carrier would require transmission at a transmit power of −15.0 dBm. The UE 115 may estimate that a transceiver current associated with UL communication (e.g., transmission) on the second component carrier (utilizing LTE band 41) would be approximately 200 mA. The UE 115 may accordingly determine that it would be power efficient to switch the anchor carrier (e.g., or PCC) from the first carrier component to the second carrier component in the DL CA mode.

Additional transmission current consumption relationship examples for component carriers associated with CA configurations will become apparent to one skilled in the art given the benefit of the present disclosure. Additionally, aspects of the transceiver current to transmit power plot 400, similar information plots, and transmit current to transmit power characteristics derived therefrom can be applied to a transmission current consumption LUT utilized by the UE 115.

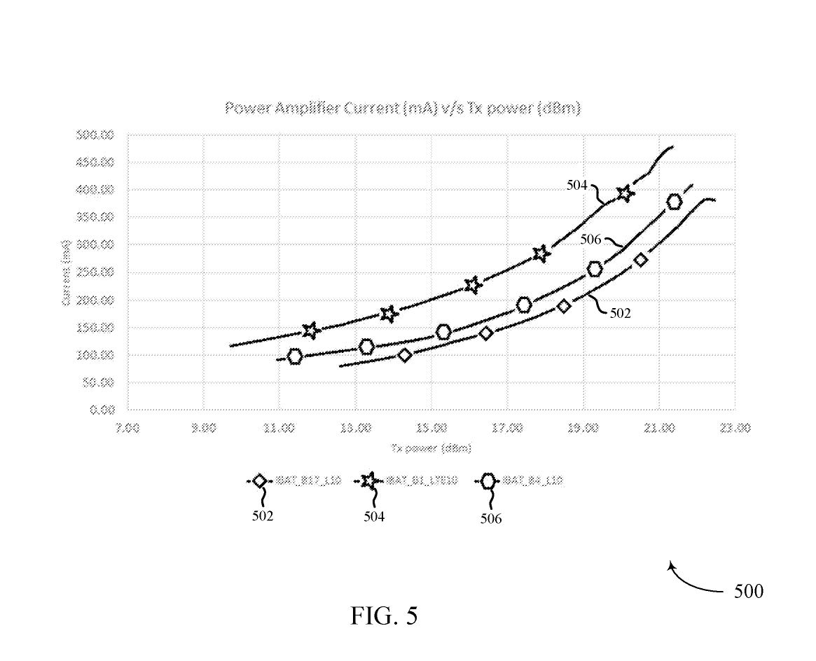

FIG. 5 illustrates an example of a power amplifier current to transmit power plot 500 that can be used for determining a transmission current consumption relationship in accordance with aspects of the present disclosure. The example information associated with the power amplifier current to transmit power plot 500 may be used by a UE 115 as described with reference to FIGS. 1 through 3. Additionally, the example information associated with power amplifier current to transmit power plot 500 can be used in conjunction with the example information associated with the transceiver current to transmit power plot 400 in accordance with the anchor carrier selection techniques described herein. For example, the power amplifier current to transmit power plot 500, the transceiver current to transmit power plot 400, similar information plots, and transmit current to power characteristics derived therefrom can be used for determining a transmission current consumption relationship between one or more component carriers of a UE 115. It is to be understood that the specific numerical values for power amplifier current (mA) and transmit power (dBm) are examples for illustration purposes only, and therefore aspects and features associated with transmission current consumption relationships described herein are not limited to FIG. 5.

Plot line 502 corresponds to the power amplifier current to transmit power characteristics of a power amplifier (e.g., a power amplifier 318 associated with one of one or more of transmit chains 310-a, 310-b, 310-c, and 310-d of FIG. 3) operating in LTE band 17. Plot line 504 corresponds to the power amplifier current to transmit power characteristics of a power amplifier (e.g., a power amplifier 318 associated with one of one or more of transmit chains 310-a, 310-b, 310-c, and 310-d of FIG. 3) operating in LTE band 1. Plot line 506 corresponds to the power amplifier current to transmit power characteristics of a power amplifier (e.g., a power amplifier 318 associated with one of one or more of transmit chains 310-a, 310-b, 310-c, and 310-d of FIG. 3) operating in LTE band 4.

In one example of a transmission current consumption relationship, a UE 115 may have a first component carrier in a DL CA mode that is operating on LTE band 17 and a second component carrier in the DL CA mode operating on LTE band 4. The first component carrier may be designated as the anchor carrier (e.g., or PCC) and may be transmitting at a transmit power of 17.0 dBm. The UE 115 may estimate that a power amplifier current associated with UL communication (e.g., transmission) on the first component carrier (utilizing LTE band 17) is approximately 150 mA. The second component carrier may be designated as an SCC and may have a received power metric such that the UE 115 may estimate that, if the second component carrier were selected as the anchor carrier (e.g., or PCC), the second component carrier would require transmission at a transmit power of 15.0 dBm.

The UE 115 may estimate that a power amplifier current associated with UL communication (e.g., transmission) on the second component carrier (utilizing LTE band 4) would be approximately 140 mA. The UE 115 may determine that the power efficiency saving of 10 mA to switch the anchor carrier (e.g., or PCC) from the first carrier component to the second carrier component does not satisfy a hysteresis parameter (e.g., a current performance increase of at least 20 mA) for satisfying a performance increase threshold, and therefore the UE 115 may not recommend switching the anchor carrier (e.g., or PCC) associated with the DL CA mode in this example case.

Additional transmission current consumption relationship examples for component carriers associated with CA configurations will become apparent to one skilled in the art given the benefit of the present disclosure. Additionally, aspects of the power amplifier current to transmit power plot 500, similar information plots, and power amplifier current to transmit power characteristics derived therefrom can be applied to a transmission current consumption LUT utilized by the UE 115.

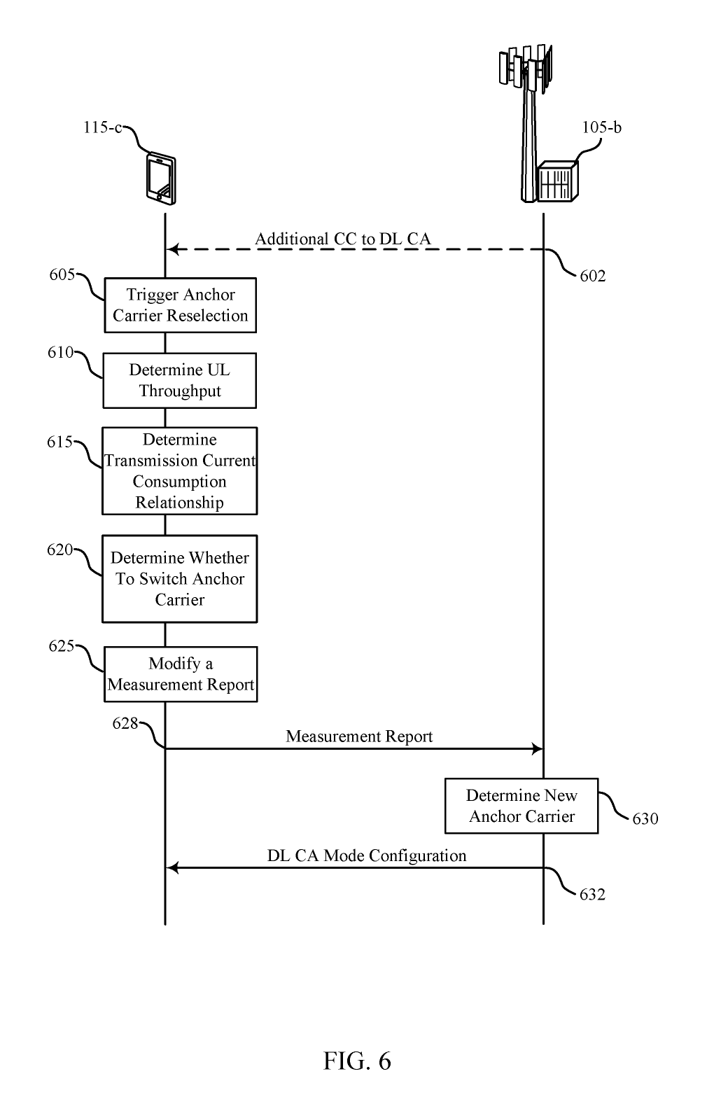

FIG. 6 illustrates an example of a process flow 600 that supports UE anchor carrier selection in accordance with aspects of the present disclosure. UE 115-c and base station 105-b may be examples of aspects of a UE 115 and a base station 105 as described with reference to FIGS. 1 through 5. The described techniques are discussed for cells operating in dedicated spectrum using LTE-A communications in a DL CA mode. However, it is to be understood that the described techniques are applicable to other spectrum environments, for example, where a combination of dedicated, unlicensed, and/or shared spectrum may be utilized for component carriers in DL CA and other CA modes and operations.

The UE 115-c and the base station 105-b may be operating in a DL CA mode. A first component carrier may be designated as the anchor carrier (e.g., or PCC) and a second component carrier may be designated as an SCC in the DL CA mode. In some cases, the base station 105-b may transmit instructions 602 to the UE 115-c informing the UE 115-c that one or more additional component carriers (e.g., a second SCC) are to be added to the aggregate carrier of the existing DL CA mode.

At operation 605, the UE 115-c may trigger an anchor carrier reselection process. In some examples, the UE 115-c may determine whether to switch to a different anchor carrier based at least in part on the instruction 602 that addition of one or more additional component carriers are to be added. For example, if a DL CA mode includes two component carriers and a third component carrier is added (e.g., to increase the DL bandwidth), UE 115-c may initiate operations for determining which of the all component carriers (e.g., including the one or more newly added component carriers) of the DL CA mode would be the most power efficient anchor carrier.

In some examples, the trigger for determining whether to switch the anchor carrier of operation 605 is based at least in part on a time interval or period associated with using the DL CA mode. Additionally or alternatively, the time interval or period for which to trigger determining whether to switch the anchor carrier may be modified based at least in part on a battery condition. For example, if the remaining battery power of the UE 115-c is above a threshold (e.g., 80%), the time interval or period for which to trigger determining whether to switch the anchor carrier may be a first value (e.g., 10 seconds) or the UE 115-c may determine not to initiate a trigger for determining whether to switch that anchor carrier. If the remaining battery power of the UE 115-c is below a threshold (e.g., 20%), the time interval or period for which to trigger determining whether to switch the anchor carrier may be a second value (e.g., 200 milliseconds or less). In this manner, the techniques for selecting a power efficient anchor carrier may include a scheme where deference with respect to anchor carrier selection is given to the base station 105-b when the remaining battery power of the UE 115-c is high, but current consumption with respect to the UL communication (e.g., transmission) is given greater significance when the remaining battery power of the UE 115-c is low.

In other examples, the trigger for determining whether to switch an anchor carrier of operation 605 is based at least in part on a change in the receive power metrics associated with the component carriers of the DL CA mode. For example, the UE 115-c may periodically poll the receive power of first component carrier and the second component carrier. The UE 115-c may determine a receive power metric (e.g., a reference signal receive power (RSRP) or a received signal strength indicator (RSSI) associated with each of the first component carrier and the second component carrier. When a change between the receive power metrics of the at least two of the component carriers of the DL CA mode satisfies a threshold (e.g., a change corresponding to greater than 5 to 7 dB in receive power), the UE 115-c may initiate operations for determining whether to switch the anchor carrier.

At operation 610, the UE 115-c may determine UL throughput requirements associated with the DL CA mode. UE 115-c may determine the UL throughput requirements and may determine whether one or more of the SCCs are capable of satisfying the UL throughput requirements. For example, the UE 115-c may whether the second component carrier of the component carriers in the DL CA mode satisfies the UL throughput requirements. In some cases, the UE 105-c may determine throughput requirements associated with an UL data transmission based at least in part on an application executed by the UE 115-c. For example, the UE 115-c may have some historical data associated with UL communications (e.g., transmissions) to determine the throughput requirements corresponding to the DL CA mode.

Based at least in part on the UE 115-c determining that the UL throughput requirements are satisfied by the second component carrier, the UE 115-c may determine a transmit power level associated with the first component carrier, which is presently the anchor carrier (e.g., or PCC) of the DL CA mode. The UE 115-c may estimate a transmit power level associated with one or more of the component carriers that are SCCs in the DL CA mode. For example, the UE 115-c may estimate a transmit power level associated with the second component carrier. The UE 115-c may estimate the transmit power level associated with the second component carrier by estimating a power level required for UL transmission on a carrier frequency band of the second component carrier.

In some cases, the UE 115-c may estimate the transmit power level associated with the second component carrier based at least in part on a receive power associated with the second component carrier (e.g., a component carrier not presently selected as the anchor carrier).

At operation 615, the UE 115-c may determine a transmission current consumption relationship. The transmission current consumption relationship may be based at least in part on the determined first transmit power level (associated with the first component carrier) and the estimated second transmit power level (associated with the second component carrier). The UE 115-c may determine the transmission current consumption relationship by comparing a transmission current value associated with the first transmit power level and an estimated transmission current value associated with the second transmit power level. The transmission current value associated with the first transmit power level can be an actual value from transmission operations of the UE 115-c. In some cases, the UE 115-c may determine the transmission current value associated with the first transmit power level by estimating the transmission current value associated with the first transmit power level. This estimated transmission current value may be used despite the fact that the UE 115-c could obtain actual values (e.g., when first transmit power level estimations are sufficient for the comparison purposes and the estimations take less time and/or require fewer processing resources than the obtaining actual values).

Additionally, in some examples, the UE 115-c may determine the transmission current consumption relationship by referencing a transmission current estimation LUT. For example, the transmission current estimation LUT may include a plurality of power amplifier current consumption values. Each power amplifier current consumption value may be with a transmit power level and a carrier frequency band and/or an UL transmission bandwidth.

In some cases, the transmission current consumption relationship may be determined by the UE 115-c based at least in part on inherent current consumption information for a particular carrier frequency band based on different power amplifiers in the transmit chain and/or radio frequency front end components (e.g., inherent current consumption information derived from different types of transmit chain components associated with a given radio access technology or derived from similar characteristics between component carriers of the DL CA mode). In some cases, the transmission current consumption relationship current consumption may be determined by the UE 115-c based at least in part on operational current consumption inference information (e.g., current consumption estimates based at least in part on a bandwidth of UL transmission of similar component carriers or substantial temperature changes to associated with a transmit chain of a presently selected anchor carrier and corresponding current consumption changes).

In some cases, the transmission current consumption relationship may be determined by the UE 115-c based at least in part on an estimated transmit power level that would be required if the component carrier and corresponding carrier frequency band is selected to be a particular carrier frequency band. For example, the UE 115-c may determine a first receive power associated with DL transmission on the first component carrier and a second receive power associated with DL transmission on the second component carrier. The first component carrier may have a receive power value of Rx1 and the second component carrier may have a receive power value of Rx2. The UL transmission occurs on the first carrier component, which is presently the anchor carrier or PCC, at a transmit power level P1. The UE 115-c can identify a first current value I1 associated with the first carrier component and a second current value I2 associated with the second component carrier. The UE 115-c may can identify the first current value I1 and the second current value I2 based at least in part on referencing the transmission current estimation LUT with the transmit power level P1 for the first component carrier and the second transmit power level P2 for the second component carrier, respectively (see, e.g., FIGS. 4 and 5 as transmission current consumption relationship examples for component carriers associated with different carrier frequency bands).

At operation 620, the UE 115-c may determine, based at least in part on the transmission current consumption relationship, whether to switch the anchor carrier or PCC from the first component carrier to the second component carrier in the DL CA mode. For example, if I1-I2 is above a threshold (e.g., a predefined threshold) and/or a hysteresis parameter for satisfying a performance increase threshold (e.g., a variable hysteresis parameter based at least in part on operational conditions), the UE 115-c may determine that selecting the second component carrier as the anchor carrier or PCC would be an efficient use of the remaining battery power of UE 115-c.

In some cases, the UE 115-c may determine to switch the anchor carrier or PCC from the first component carrier to the second component carrier based at least in part on a bandwidth of the first component carrier (e.g., a 20 MHz channel bandwidth) being larger than a bandwidth of the second component carrier (e.g., a 10 MHz channel bandwidth). In some cases, the UE 115-c may identify that the first component carrier corresponds to a first transmit chain and the second component carrier corresponds to a second transmit chain different from the first transmit chain. The UE 115-c may determine to whether to switch the anchor carrier or PCC from the first component carrier to the second component carrier is further based at least in part on a temperature change associated with one or more components of the first transmit chain. For example, if the temperature change is indicative of a substantial power change to the first component carrier (e.g., a change to the transmit current required for UL transmission and/or the total transceiver power required for UL and DL transmissions). For example, the UE 115-c may determine to switch the anchor carrier or the PCC from the first component carrier to the second component carrier based at least in part on the temperature change associated with one or more components of the first transmit chain satisfying a transmission performance decrease threshold (e.g., a 10-50% transmission performance decrease depending on the type of transmit chains utilized by each of the first and second component carriers).

In some cases, the first component carrier and the second component carrier are an LTE-A radio frequency spectrum bands. In some cases, the first component carrier is an LTE-A radio frequency spectrum band and the second component carrier is a different type of component carrier such as an unlicensed radio frequency spectrum band. When the second component carrier is a different type of component carrier, the UE 115-c will determine whether the second type of carrier is capable of being an anchor carrier or PCC for the DL CA mode before determining whether the second component carrier is a viable alternative anchor carrier or PCC.

Based at least in part on the determining to switch the anchor carrier or PCC from the first component carrier to the second component carrier, the UE 115-c may modify a measurement report to satisfy a condition for switching the anchor carrier from the first component carrier to the second component carrier in the DL CA mode. In some examples, the measurement report may be modified to interchange the first component carrier and the second component carrier in the DL CA mode. In some examples, the UE 115-c may altered an A5 measurement report to force a handover so that the anchor carrier or PCC is switched from the first component carrier to the second component carrier.

The UE 115-c may transmit a message 628 including the modified measurement to the base station 105-b. In some cases, the message 628 may be transmitted in the normal course of handover operations between the UE 115-c and the base station 105-b. In some cases, for example, a PCell (and the corresponding PCC) may only be permitted to change with a handover procedure (e.g., with security key change and random access channel procedure). In some cases, the UE 115-c may transmit an indication (e.g., set a bit in a channel quality reporting field or provide an additional message) to the base station 105-c that the measurement report has been modified. In this manner, the base station 105-b can override the measurement report to accommodate load balancing or other consideration for selecting an anchor carrier or PCC.

In aspects, at operation 630, the base station 105-b may review the measurement report and modify the DL CA mode configuration so that the second carrier is second component carrier is the anchor carrier or PCC. The base station 105-b may transmit instructions 632 for modifying the DL CA mode configuration to the UE 115-c, and the UE 115-c may receive such instructions 632. The base station 105-b may also transmit additional instructions to other network elements responsible for providing the DL CA mode to UE 115-c (e.g., an access point or other device providing a component carrier).

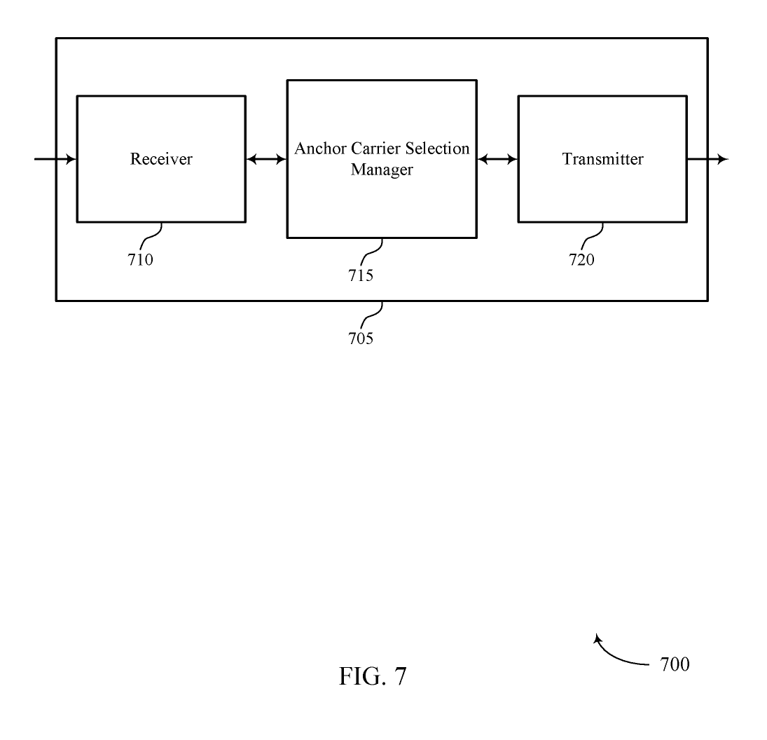

FIG. 7 shows a block diagram 700 of a wireless device 705 that supports selecting a power efficient anchor carrier in accordance with various aspects of the present disclosure. Wireless device 705 may be an example of aspects of a user equipment (UE) 115 as described with reference to FIGS. 1 through 6. Wireless device 705 may include receiver 710, anchor carrier selection manager 715, and transmitter 720. Wireless device 705 may also include a processor. Each of these components may be in communication with one another (e.g., via one or more buses).

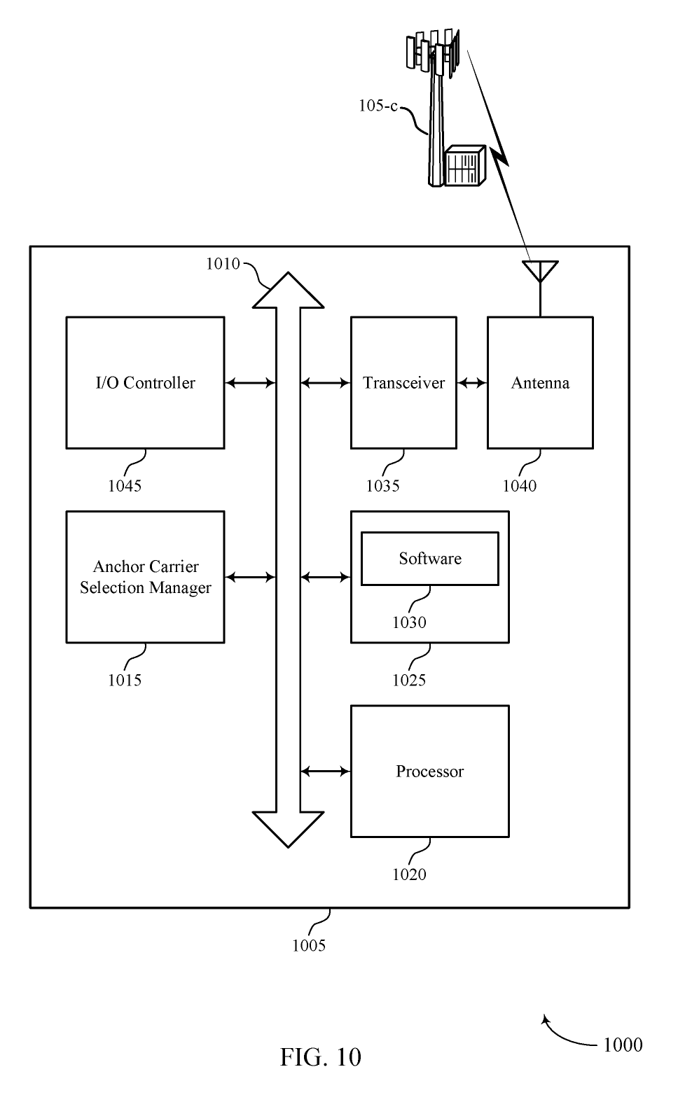

Receiver 710 may receive information such as packets, user data, or control information associated with various information channels (e.g., control channels, data channels, and information related to selecting a power efficient anchor carrier, etc.). Information may be passed on to other components of the device. The receiver 710 may be an example of aspects of the transceiver 1035 described with reference to FIG. 10.

Anchor carrier selection manager 715 may be an example of aspects of the anchor carrier selection manager 1015 described with reference to FIG. 10.

Anchor carrier selection manager 715 may determine a second component carrier of a set of component carriers in a DL CA mode satisfies throughput requirements associated with an UL data transmission, determine, based on the throughput requirements being satisfied, a first transmit power level associated with a first component carrier of the set of component carriers, the first component carrier being an anchor carrier for the set of component carriers in the DL CA mode, estimate a second transmit power level associated with the second component carrier, determine, based on the first transmit power level and the second transmit power level, a transmission current consumption relationship, and determine, based on the transmission current consumption relationship, whether to switch the anchor carrier from the first component carrier to the second component carrier in the DL CA mode.

The anchor carrier selection manager 715 may also determine a first transmit power level associated with a first component carrier of a set of component carriers, the first component carrier being an anchor carrier for the set of component carriers in a DL CA mode, estimate a second transmit power level associated with a second component carrier of the set of component carriers, determine, based on the first transmit power level and the second transmit power level, a transmission current consumption relationship in the DL CA mode, determine, based on the determining the transmission current consumption relationship, to switch the anchor carrier from the first component carrier to the second component carrier in the DL CA mode, and modify a measurement report, based on the determining to switch the anchor carrier, to satisfy a condition for switching the anchor carrier from the first component carrier to the second component carrier in the DL CA mode.

Transmitter 720 may transmit signals generated by other components of the device. In some examples, the transmitter 720 may be collocated with a receiver 710 in a transceiver module. For example, the transmitter 720 may be an example of aspects of the transceiver 1035 described with reference to FIG. 10. The transmitter 720 may also be an example of aspects of the one or more of transmit chains 310-a, 310-b, 310-c, and 310-d described with reference to FIG. 3. The transmitter 720 may include a single antenna, or it may include a set of antennas.

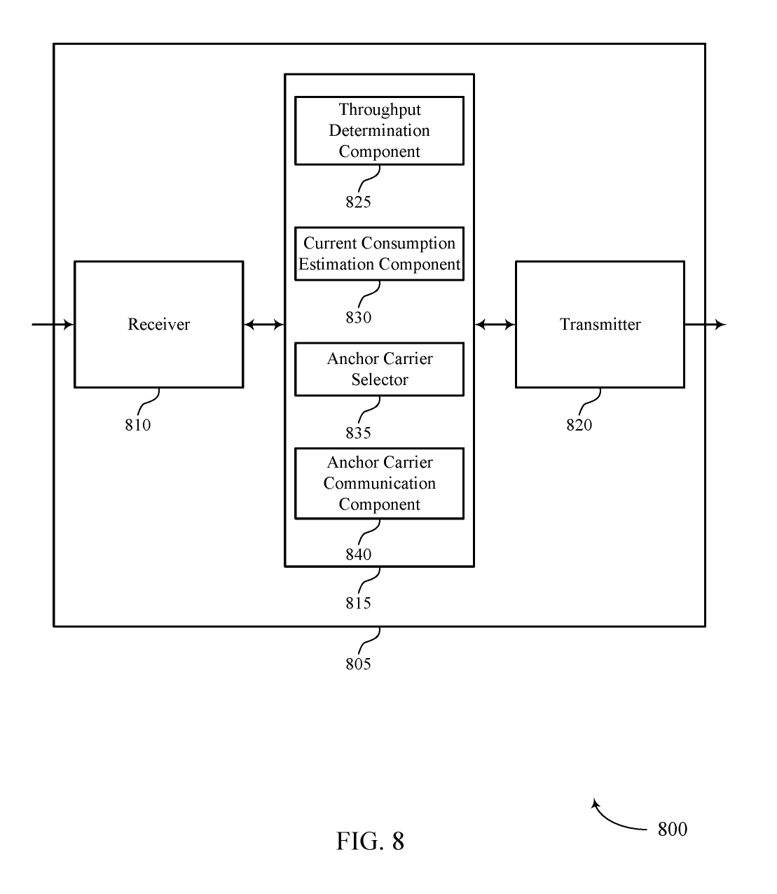

FIG. 8 shows a block diagram 800 of a wireless device 805 that supports selecting a power efficient anchor carrier in accordance with various aspects of the present disclosure. Wireless device 805 may be an example of aspects of a wireless device 705 or a UE 115 as described with reference to FIGS. 1 through 7. Wireless device 805 may include receiver 810, anchor carrier selection manager 815, and transmitter 820. Wireless device 805 may also include a processor. Each of these components may be in communication with one another (e.g., via one or more buses).

Receiver 810 may receive information such as packets, user data, or control information associated with various information channels (e.g., control channels, data channels, and information related to selecting a power efficient anchor carrier, etc.). Information may be passed on to other components of the device. The receiver 810 may be an example of aspects of the transceiver 1035 described with reference to FIG. 10.

Anchor carrier selection manager 815 may be an example of aspects of the anchor carrier selection manager 1015 described with reference to FIG. 10.

Anchor carrier selection manager 815 may also include throughput determination component 825, current consumption estimation component 830, anchor carrier selector 835, and anchor carrier communication component 840.

Throughput determination component 825 may determine a second component carrier of a set of component carriers in a DL CA mode satisfies throughput requirements associated with an UL data transmission and determine throughput requirements associated with an UL data transmission based on an application executed by the UE.

Current consumption estimation component 830 may determine a first transmit power level associated with a first component carrier of a set of component carriers, the first component carrier being an anchor carrier for the set of component carriers in a DL CA mode. In some examples, current consumption estimation component 830 may determine, based on the throughput requirements being satisfied, the first transmit power level associated with the first component carrier of the set of component carriers.

Current consumption estimation component 830 may estimate a second transmit power level associated with the second component carrier and determine, based on the first transmit power level and the second transmit power level, a transmission current consumption relationship.

In some cases, the estimating the second transmit power level associated with the second component carrier includes estimating a power level required for uplink transmission on a carrier frequency band of the second component carrier. In some cases, the estimating the second transmit power level associated with the second component carrier includes estimating the second transmit power level associated with the second component carrier based on a receive power associated with the second component carrier in the DL CA mode.

In some cases, the determining the transmission current consumption relationship includes comparing a transmission current value associated with the first transmit power level and an estimated transmission current value associated with the second transmit power level. In some cases, the transmission current value associated with the first transmit power level is an estimated transmission current value associated with the first transmit power level.

In some cases, the determining the transmission current consumption relationship includes referencing a transmission current estimation look-up table (LUT), the transmission current estimation LUT including a set of power amplifier current consumption values, each power amplifier current consumption value associated with at least one of a transmit power level and a carrier frequency band or an UL transmission bandwidth. In some cases, the determining the transmission current consumption relationship includes determining a hysteresis parameter for satisfying a performance increase threshold.

Current consumption estimation component 830 may also identify that the first component carrier corresponds to a first transmit chain and the second component carrier corresponds to a second transmit chain different from the first transmit chain.

Anchor carrier selector 835 may determine, based on the transmission current consumption relationship, whether to switch the anchor carrier from the first component carrier to the second component carrier in the DL CA mode. Anchor carrier selector 835 may determine, based on the determining the transmission current consumption relationship, to switch the anchor carrier from the first component carrier to the second component carrier in the DL CA mode. In aspects, the anchor carrier selector 835 may determine, based on the determining the transmission current consumption relationship, to switch the anchor carrier from the first component carrier with the second component carrier in the DL CA mode.

In some examples, anchor carrier selector 835 may determine to switch the anchor carrier from the first component carrier to the second component carrier based on a bandwidth of the first component carrier being larger than a bandwidth of the second component carrier.

In some examples, anchor carrier selector 835 determine to switch the anchor carrier from the first component carrier to the second component carrier based on the temperature change associated with one or more components of the first transmit chain satisfying a transmission performance decrease threshold.

Anchor carrier communication component 840 may modify a measurement report, based on the determining to switch the anchor carrier, to satisfy a condition for switching the anchor carrier from the first component carrier to the second component carrier in the DL CA mode. In some cases, the modifying the measurement report to satisfy a condition for switching the anchor carrier includes modifying the measurement report to interchange the first component carrier and the second component carrier in the DL CA mode. In some cases, the modifying the measurement report includes modifying an A5 measurement report such that a received power metric associated with one of the first component carrier or the second component carrier is altered.

Anchor carrier communication component 840 may transmit, in cooperation with transmitter 820, the measurement report to a base station. In some examples, anchor carrier communication component 840 may also transmit, in cooperation with transmitter 820, an indication that the measurement report has been modified to a base station.

Transmitter 820 may transmit signals generated by other components of the device. In some examples, the transmitter 820 may be collocated with a receiver 810 in a transceiver module. For example, the transmitter 820 may be an example of aspects of the transceiver 1035 described with reference to FIG. 10. The transmitter 820 may include a single antenna, or it may include a set of antennas.

In some cases, a carrier frequency band of the first component carrier is an LTE-A radio frequency spectrum band. In some cases, a carrier frequency band of the second component carrier is an unlicensed radio frequency spectrum band.

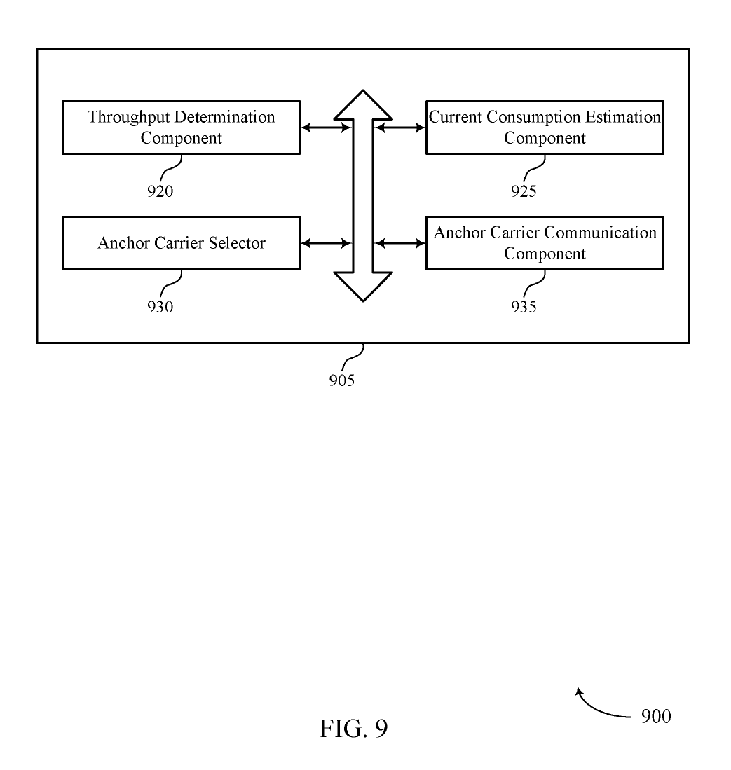

FIG. 9 shows a block diagram 900 of an anchor carrier selection manager 915 that supports selecting a power efficient anchor carrier in accordance with various aspects of the present disclosure. The anchor carrier selection manager 915 may be an example of aspects of an anchor carrier selection manager 715, an anchor carrier selection manager 815, or an anchor carrier selection manager 1015 described with reference to FIGS. 7, 8, and 10. The anchor carrier selection manager 915 may include throughput determination component 920, current consumption estimation component 925, anchor carrier selector 930, and anchor carrier communication component 935. Each of these modules may communicate, directly or indirectly, with one another (e.g., via one or more buses).

Throughput determination component 920 may determine a second component carrier of a set of component carriers in a DL CA mode satisfies throughput requirements associated with an UL data transmission. In some examples, throughput determination component 920 may determine the throughput requirements associated with an UL data transmission based on an application executed by the UE.

Current consumption estimation component 925 may determine a first transmit power level associated with a first component carrier of a set of component carriers, the first component carrier being an anchor carrier for the set of component carriers in a DL CA mode. In some examples, current consumption estimation component 925 may determine, based on the throughput requirements being satisfied, the first transmit power level associated with the first component carrier of the set of component carriers, the first component carrier being an anchor carrier for the set of component carriers in the DL CA mode.

Current consumption estimation component 925 may estimate a second transmit power level associated with the second component carrier and determine, based on the first transmit power level and the second transmit power level, a transmission current consumption relationship.

In some cases, the estimating the second transmit power level associated with the second component carrier includes estimating a power level required for UL transmission on a carrier frequency band of the second component carrier. In some cases, the estimating the second transmit power level associated with the second component carrier includes estimating the second transmit power level associated with the second component carrier based on a receive power associated with the second component carrier in the DL CA mode.

In some cases, the determining the transmission current consumption relationship includes comparing a transmission current value associated with the first transmit power level and an estimated transmission current value associated with the second transmit power level. In some cases, the transmission current value associated with the first transmit power level is an estimated transmission current value associated with the first transmit power level.

In some cases, the determining the transmission current consumption relationship includes referencing a transmission current estimation look-up table (LUT), the transmission current estimation LUT including a set of power amplifier current consumption values, each power amplifier current consumption value associated with at least one of a transmit power level and a carrier frequency band or an UL transmission bandwidth. In some cases, the determining the transmission current consumption relationship includes determining a hysteresis parameter for satisfying a performance increase threshold.

Current consumption estimation component 925 may identify that the first component carrier corresponds to a first transmit chain and the second component carrier corresponds to a second transmit chain different from the first transmit chain.

Anchor carrier selector 930 may determine, based on the transmission current consumption relationship, whether to switch the anchor carrier from the first component carrier to (e.g., or with) the second component carrier in the DL CA mode. Anchor carrier selector 930 may determine, based on the determining the transmission current consumption relationship, to switch the anchor carrier from the first component carrier to (e.g., or with) the second component carrier in the DL CA mode.

In some examples, anchor carrier selector 930 may determine to switch the anchor carrier from the first component carrier to (e.g., or with) the second component carrier based on a bandwidth of the first component carrier being larger than a bandwidth of the second component carrier.

In some examples, anchor carrier selector 930 may determine to switch the anchor carrier from the first component carrier to (e.g., or with) the second component carrier based on the temperature change associated with one or more components of the first transmit chain satisfying a transmission performance decrease threshold.

Anchor carrier communication component 935 may modify a measurement report, based on the determining to switch the anchor carrier, to satisfy a condition for switching the anchor carrier from the first component carrier to the second component carrier in the DL CA mode. In some cases, the modifying the measurement report, based on the determining to switch the anchor carrier, to satisfy a condition for switching the anchor carrier includes modifying the measurement report, based on the determining to switch the anchor carrier, to interchange the first component carrier and the second component carrier in the DL CA mode. In some cases, the modifying the measurement report includes modifying an A5 measurement report such that a received power metric associated with one of the first component carrier or the second component carrier is altered.

Anchor carrier communication component 935 may transmit, in cooperation with a transmitter, the measurement report to a base station. In some examples, the anchor carrier communication component 935 may transmit, in cooperation with a transmitter, an indication that the measurement report has been modified to a base station.

In some cases, a carrier frequency band of the first component carrier is an LTE-A radio frequency spectrum band. In some cases, a carrier frequency band of the second component carrier is an unlicensed radio frequency spectrum band.

FIG. 10 shows a diagram of a system 1000 including a device 1005 that supports selecting a power efficient anchor carrier in accordance with various aspects of the present disclosure. Device 1005 may be an example of or include the components of wireless device 705, wireless device 805, or a UE 115 as described above with reference to FIGS. 1 through 8. Device 1005 may include components for bi-directional voice and data communications including components for transmitting and receiving communications, including anchor carrier selection manager 1015, processor 1020, memory 1025, software 1030, transceiver 1035, antenna 1040, and I/O controller 1045. These components may be in electronic communication via one or more busses (e.g., bus 1010). Device 1005 may communicate wirelessly with one or more base stations 105-c.

Processor 1020 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1020 may be configured to operate a memory array using a memory controller. In other cases, a memory controller may be integrated into processor 1020. Processor 1020 may be configured to execute computer-readable instructions stored in a memory to perform various functions (e.g., functions or tasks supporting selecting a power efficient anchor carrier).

Memory 1025 may include random access memory (RAM) and read only memory (ROM). The memory 1025 may store computer-readable, computer-executable software 1030 including instructions that, when executed, cause the processor to perform various functions described herein. In some cases, the memory 1025 may contain, among other things, a basic input/output system (BIOS) which may control basic hardware and/or software operation such as the interaction with peripheral components or devices.

Software 1030 may include code to implement aspects of the present disclosure, including code to support selecting a power efficient anchor carrier. Software 1030 may be stored in a non-transitory computer-readable medium such as system memory or other memory. In some cases, the software 1030 may not be directly executable by the processor but may cause a computer (e.g., when compiled and executed) to perform functions described herein.

Transceiver 1035 may communicate bi-directionally, via one or more antennas, wired, or wireless links as described above. For example, the transceiver 1035 may represent a wireless transceiver and may communicate bi-directionally with another wireless transceiver. The transceiver 1035 may also include a modem to modulate the packets and provide the modulated packets to the antennas for transmission, and to demodulate packets received from the antennas.

In some cases, the wireless device may include a single antenna 1040. However, in some cases the device may have more than one antenna 1040, which may be capable of concurrently transmitting or receiving multiple wireless transmissions.

I/O controller 1045 may manage input and output signals for device 1005. I/O controller 1045 may also manage peripherals not integrated into device 1005. In some cases, I/O controller 1045 may represent a physical connection or port to an external peripheral. In some cases, I/O controller 1045 may utilize an operating system such as iOS®, ANDROID®, MS-DOS®, MS-WINDOWS®, OS/2®, UNIX®, LINUX®, or another known operating system.

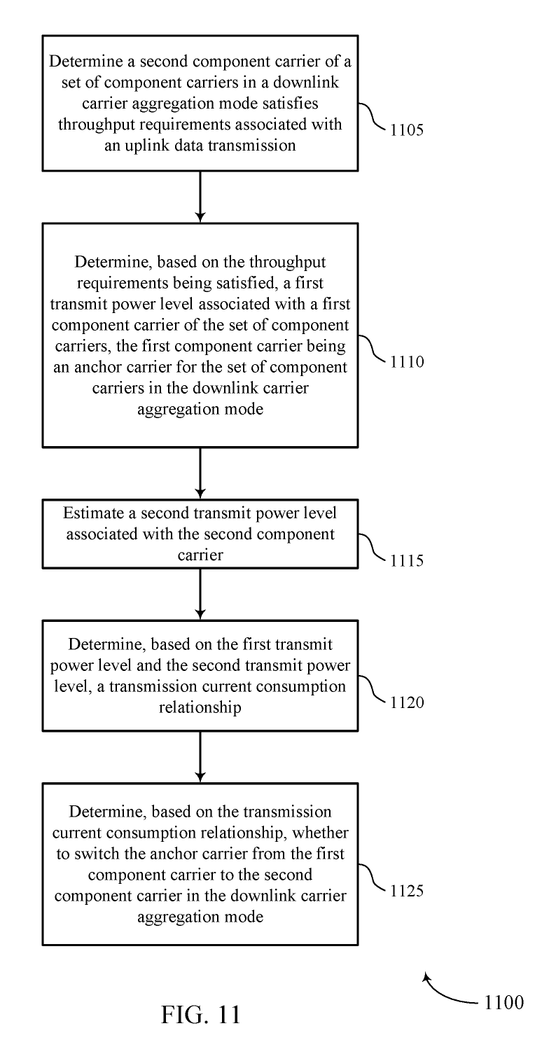

FIG. 11 shows a flowchart illustrating a method 1100 for selecting a power efficient anchor carrier in accordance with various aspects of the present disclosure. The operations of method 1100 may be implemented by a UE 115 or its components as described herein. For example, the operations of method 1100 may be performed by an anchor carrier selection manager as described with reference to FIGS. 7 through 10. In some examples, a UE 115 may execute a set of codes to control the functional elements of the device to perform the functions described below. Additionally or alternatively, the UE 115 may perform aspects of the functions described below using special-purpose hardware.

At block 1105 the UE 115 may determine a second component carrier of a plurality of component carriers in a DL CA mode satisfies throughput requirements associated with an UL data transmission. The operations of block 1105 may be performed according to the techniques described with reference to FIGS. 1 through 6. In certain examples, aspects of the operations of block 1105 may be performed by a throughput determination component as described with reference to FIGS. 7 through 10.

At block 1110 the UE 115 may determine, based at least in part on the throughput requirements being satisfied, a first transmit power level associated with a first component carrier of the plurality of component carriers, the first component carrier being an anchor carrier for the plurality of component carriers in the DL CA mode. The operations of block 1110 may be performed according to the techniques described with reference to FIGS. 1 through 6. In certain examples, aspects of the operations of block 1110 may be performed by a current consumption estimation component as described with reference to FIGS. 7 through 10.

At block 1115 the UE 115 may estimate a second transmit power level associated with the second component carrier. The operations of block 1115 may be performed according to the techniques described with reference to FIGS. 1 through 6. In certain examples, aspects of the operations of block 1115 may be performed by a current consumption estimation component as described with reference to FIGS. 7 through 10.

At block 1120 the UE 115 may determine, based at least in part on the first transmit power level and the second transmit power level, a transmission current consumption relationship. The operations of block 1120 may be performed according to the methods described with reference to FIGS. 1 through 6. In certain examples, aspects of the operations of block 1120 may be performed by a current consumption estimation component as described with reference to FIGS. 7 through 10.

At block 1125 the UE 115 may determine, based at least in part on the transmission current consumption relationship, whether to switch the anchor carrier from the first component carrier to (e.g., or with) the second component carrier in the DL CA mode. The operations of block 1125 may be performed according to the techniques described with reference to FIGS. 1 through 6. In certain examples, aspects of the operations of block 1125 may be performed by an anchor carrier selector as described with reference to FIGS. 7 through 10.

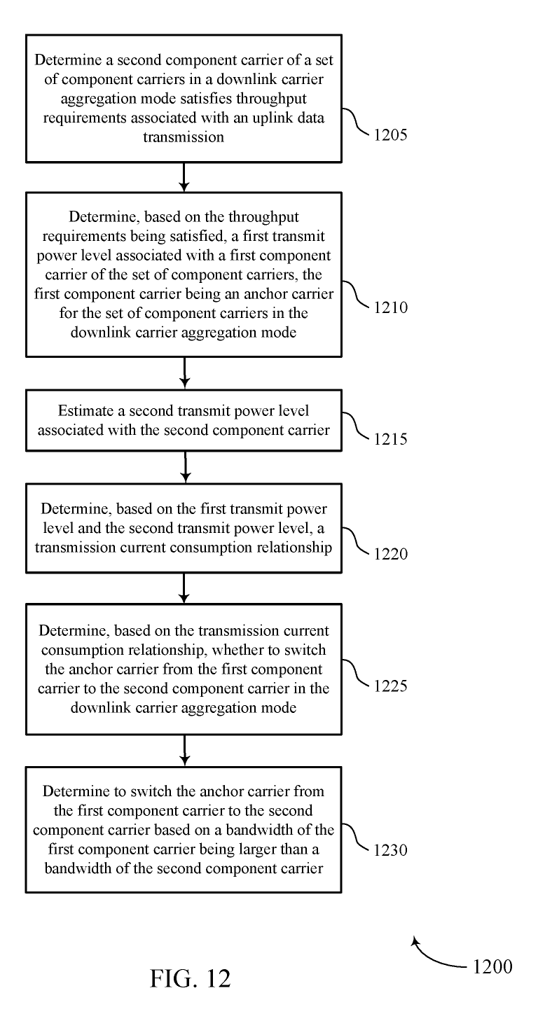

FIG. 12 shows a flowchart illustrating a method 1200 for selecting a power efficient anchor carrier in accordance with various aspects of the present disclosure. The operations of method 1200 may be implemented by a UE 115 or its components as described herein. For example, the operations of method 1200 may be performed by an anchor carrier selection manager as described with reference to FIGS. 7 through 10. In some examples, a UE 115 may execute a set of codes to control the functional elements of the device to perform the functions described below. Additionally or alternatively, the UE 115 may perform aspects of the functions described below using special-purpose hardware.

At block 1205 the UE 115 may determine a second component carrier of a plurality of component carriers in a DL CA mode satisfies throughput requirements associated with an UL data transmission. The operations of block 1205 may be performed according to the techniques described with reference to FIGS. 1 through 6. In certain examples, aspects of the operations of block 1205 may be performed by a throughput determination component as described with reference to FIGS. 7 through 10.

At block 1210 the UE 115 may determine, based at least in part on the throughput requirements being satisfied, a first transmit power level associated with a first component carrier of the plurality of component carriers, the first component carrier being an anchor carrier for the plurality of component carriers in the DL CA mode. The operations of block 1210 may be performed according to the techniques described with reference to FIGS. 1 through 6. In certain examples, aspects of the operations of block 1210 may be performed by a current consumption estimation component as described with reference to FIGS. 7 through 10.

At block 1215 the UE 115 may estimate a second transmit power level associated with the second component carrier. The operations of block 1215 may be performed according to the techniques described with reference to FIGS. 1 through 6. In certain examples, aspects of the operations of block 1215 may be performed by a current consumption estimation component as described with reference to FIGS. 7 through 10.

At block 1220 the UE 115 may determine, based at least in part on the first transmit power level and the second transmit power level, a transmission current consumption relationship. The operations of block 1220 may be performed according to the techniques described with reference to FIGS. 1 through 6. In certain examples, aspects of the operations of block 1220 may be performed by a current consumption estimation component as described with reference to FIGS. 7 through 10.

At block 1225 the UE 115 may determine, based at least in part on the transmission current consumption relationship, whether to switch the anchor carrier from the first component carrier to (e.g., or with) the second component carrier in the DL CA mode. The operations of block 1225 may be performed according to the techniques described with reference to FIGS. 1 through 6. In certain examples, aspects of the operations of block 1225 may be performed by an anchor carrier selector as described with reference to FIGS. 7 through 10.

At block 1230 the UE 115 may determine to switch the anchor carrier from the first component carrier to (e.g., or with) the second component carrier based at least in part on a bandwidth of the first component carrier being larger than a bandwidth of the second component carrier. The operations of block 1230 may be performed according to the techniques described with reference to FIGS. 1 through 6. In certain examples, aspects of the operations of block 1230 may be performed by an anchor carrier selector as described with reference to FIGS. 7 through 10.

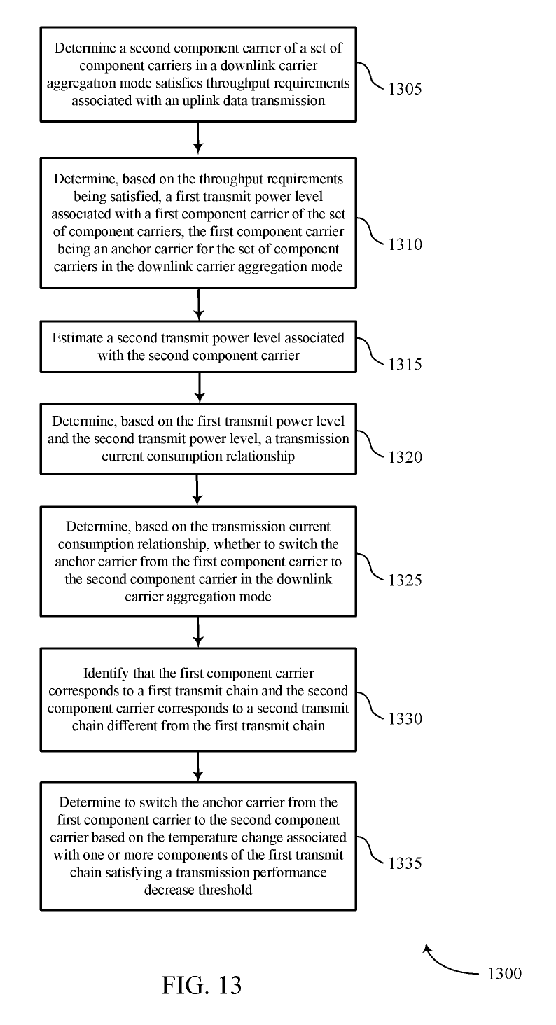

FIG. 13 shows a flowchart illustrating a method 1300 for selecting a power efficient anchor carrier in accordance with various aspects of the present disclosure. The operations of method 1300 may be implemented by a UE 115 or its components as described herein. For example, the operations of method 1300 may be performed by an anchor carrier selection manager as described with reference to FIGS. 7 through 10. In some examples, a UE 115 may execute a set of codes to control the functional elements of the device to perform the functions described below. Additionally or alternatively, the UE 115 may perform aspects of the functions described below using special-purpose hardware.

At block 1305 the UE 115 may determine a second component carrier of a plurality of component carriers in a DL CA mode satisfies throughput requirements associated with an UL data transmission. The operations of block 1305 may be performed according to the techniques described with reference to FIGS. 1 through 6. In certain examples, aspects of the operations of block 1305 may be performed by a throughput determination component as described with reference to FIGS. 7 through 10.

At block 1310 the UE 115 may determine, based at least in part on the throughput requirements being satisfied, a first transmit power level associated with a first component carrier of the plurality of component carriers, the first component carrier being an anchor carrier for the plurality of component carriers in the DL CA mode. The operations of block 1310 may be performed according to the techniques described with reference to FIGS. 1 through 6. In certain examples, aspects of the operations of block 1310 may be performed by a current consumption estimation component as described with reference to FIGS. 7 through 10.

At block 1315 the UE 115 may estimate a second transmit power level associated with the second component carrier. The operations of block 1315 may be performed according to the techniques described with reference to FIGS. 1 through 6. In certain examples, aspects of the operations of block 1315 may be performed by a current consumption estimation component as described with reference to FIGS. 7 through 10.

At block 1320 the UE 115 may determine, based at least in part on the first transmit power level and the second transmit power level, a transmission current consumption relationship. The operations of block 1320 may be performed according to the techniques described with reference to FIGS. 1 through 6. In certain examples, aspects of the operations of block 1320 may be performed by a current consumption estimation component as described with reference to FIGS. 7 through 10.

At block 1325 the UE 115 may determine, based at least in part on the transmission current consumption relationship, whether to switch the anchor carrier from the first component carrier to (e.g., or with) the second component carrier in the DL CA mode. The operations of block 1325 may be performed according to the techniques described with reference to FIGS. 1 through 6. In certain examples, aspects of the operations of block 1325 may be performed by an anchor carrier selector as described with reference to FIGS. 7 through 10.

At block 1330 the UE 115 may identify that the first component carrier corresponds to a first transmit chain and the second component carrier corresponds to a second transmit chain different from the first transmit chain. The operations of block 1330 may be performed according to the techniques described with reference to FIGS. 1 through 6. In certain examples, aspects of the operations of block 1330 may be performed by a current consumption estimation component as described with reference to FIGS. 7 through 10.

At block 1335 the UE 115 may determine to switch the anchor carrier from the first component carrier to (e.g., or with) the second component carrier based at least in part on the temperature change associated with one or more components of the first transmit chain satisfying a transmission performance decrease threshold. The operations of block 1335 may be performed according to the techniques described with reference to FIGS. 1 through 6. In certain examples, aspects of the operations of block 1335 may be performed by an anchor carrier selector as described with reference to FIGS. 7 through 10.

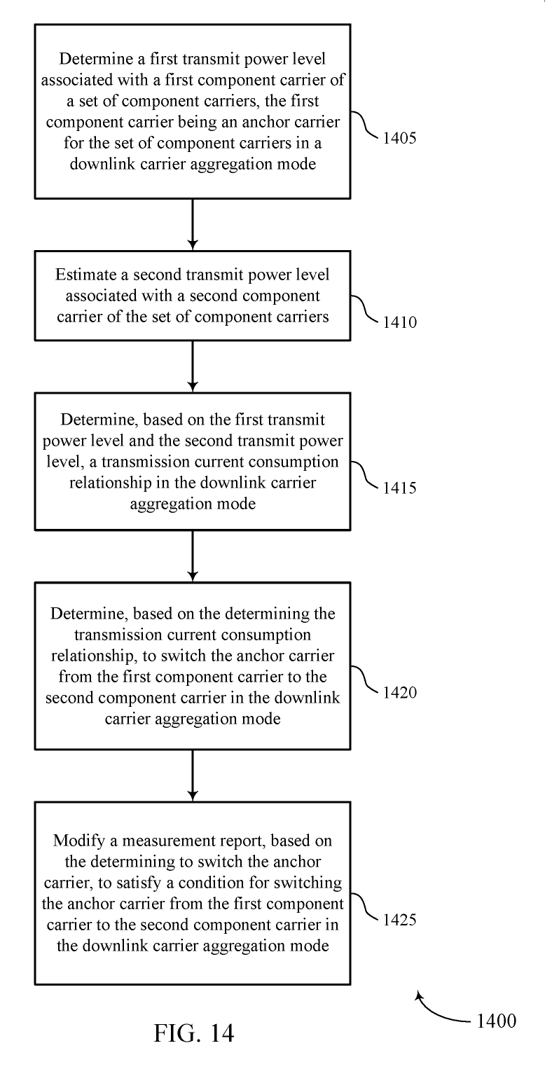

FIG. 14 shows a flowchart illustrating a method 1400 for selecting a power efficient anchor carrier in accordance with various aspects of the present disclosure. The operations of method 1400 may be implemented by a UE 115 or its components as described herein. For example, the operations of method 1400 may be performed by an anchor carrier selection manager as described with reference to FIGS. 7 through 10. In some examples, a UE 115 may execute a set of codes to control the functional elements of the device to perform the functions described below. Additionally or alternatively, the UE 115 may perform aspects of the functions described below using special-purpose hardware.

At block 1405 the UE 115 may determine a first transmit power level associated with a first component carrier of a plurality of component carriers, the first component carrier being an anchor carrier for the plurality of component carriers in a DL CA mode. The operations of block 1405 may be performed according to the techniques described with reference to FIGS. 1 through 6. In certain examples, aspects of the operations of block 1405 may be performed by a current consumption estimation component as described with reference to FIGS. 7 through 10.

At block 1410 the UE 115 may estimate a second transmit power level associated with a second component carrier of the plurality of component carriers. The operations of block 1410 may be performed according to the techniques described with reference to FIGS. 1 through 6. In certain examples, aspects of the operations of block 1410 may be performed by a current consumption estimation component as described with reference to FIGS. 7 through 10.

At block 1415 the UE 115 may determine, based at least in part on the first transmit power level and the second transmit power level, a transmission current consumption relationship in the DL CA mode. The operations of block 1415 may be performed according to the techniques described with reference to FIGS. 1 through 6. In certain examples, aspects of the operations of block 1415 may be performed by a current consumption estimation component as described with reference to FIGS. 7 through 10.

At block 1420 the UE 115 may determine, based at least in part on the determining the transmission current consumption relationship, to switch the anchor carrier from the first component carrier to (e.g., or with) the second component carrier in the DL CA mode. The operations of block 1420 may be performed according to the techniques described with reference to FIGS. 1 through 6. In certain examples, aspects of the operations of block 1420 may be performed by an anchor carrier selector as described with reference to FIGS. 7 through 10.

At block 1425 the UE 115 may modify a measurement report, based at least in part on the determining to switch the anchor carrier, to satisfy a condition for switching the anchor carrier from the first component carrier to (e.g., or with) the second component carrier in the DL CA mode. The operations of block 1425 may be performed according to the techniques described with reference to FIGS. 1 through 6. In certain examples, aspects of the operations of block 1425 may be performed by an anchor carrier communication component as described with reference to FIGS. 7 through 10.

It should be noted that the methods described above describe possible implementations, and that the operations and the steps may be rearranged or otherwise modified and that other implementations are possible. Furthermore, aspects from two or more of the methods may be combined, and additional aspects as described with reference to FIGS. 1 through 10 may be added to methods described above.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-advanced (LTE-a) are new releases of UMTS that use E-UTRA. UTRA, E-UTRA, UMTS, LTE, LTE-a, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-a networks, including such networks described herein, the term eNB may be generally used to describe the base stations. The wireless communications system or systems described herein may include a heterogeneous LTE/LTE-a network in which different types of eNBs provide coverage for various geographical regions. For example, each eNB or base station may provide communication coverage for a macro cell, a small cell, or other types of cell.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, shared, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The DL transmissions described herein may also be called forward link transmissions while the UL transmissions may also be called reverse link transmissions. Each communication link described herein—including, for example, wireless communications system 100 and 200 of FIGS. 1, 2A, and 2B—may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using FDD (e.g., using paired spectrum resources) or TDD operation (e.g., using unpaired spectrum resources). Frame structures may be defined for FDD (e.g., frame structure type 1) and TDD (e.g., frame structure type 2).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and managers described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communications by a user equipment (UE), comprising:
determining a second component carrier of a plurality of component carriers in a downlink carrier aggregation mode satisfies throughput requirements associated with an uplink data transmission;
determining, based at least in part on the throughput requirements being satisfied, a first transmit power level associated with a first component carrier of the plurality of component carriers, the first component carrier being an anchor carrier for the plurality of component carriers in the downlink carrier aggregation mode;
estimating a second transmit power level associated with the second component carrier;
determining, based at least in part on the first transmit power level and the second transmit power level, a transmission current consumption relationship; and
determining, based at least in part on the transmission current consumption relationship, whether to switch the anchor carrier from the first component carrier to the second component carrier in the downlink carrier aggregation mode.

2. The method of claim 1, further comprising:
determining to switch the anchor carrier from the first component carrier to the second component carrier based at least in part on a bandwidth of the first component carrier being larger than a bandwidth of the second component carrier.

3. The method of claim 1, further comprising:
identifying that the first component carrier corresponds to a first transmit chain and the second component carrier corresponds to a second transmit chain different from the first transmit chain;
wherein the determining of whether to switch the anchor carrier from the first component carrier to the second component carrier is further based at least in part on a temperature change associated with one or more components of the first transmit chain.

4. The method of claim 3, further comprising:
determining to switch the anchor carrier from the first component carrier to the second component carrier based at least in part on the temperature change associated with one or more components of the first transmit chain satisfying a transmission performance decrease threshold.

5. The method of claim 1, wherein the estimating the second transmit power level associated with the second component carrier comprises estimating a power level required for uplink transmission on a carrier frequency band of the second component carrier.

6. The method of claim 1, wherein the estimating the second transmit power level associated with the second component carrier comprises estimating the second transmit power level associated with the second component carrier based at least in part on a receive power associated with the second component carrier in the downlink carrier aggregation mode.

7. The method of claim 1, wherein the determining the transmission current consumption relationship comprises comparing a transmission current value associated with the first transmit power level and an estimated transmission current value associated with the second transmit power level.

8. The method of claim 7, wherein the transmission current value associated with the first transmit power level is an estimated transmission current value associated with the first transmit power level.

9. The method of claim 1, wherein the determining the transmission current consumption relationship comprises referencing a transmission current estimation look-up table (LUT), the transmission current estimation LUT including a plurality of power amplifier current consumption values, each power amplifier current consumption value associated with at least one of a transmit power level and a carrier frequency band or an uplink transmission bandwidth.

10. The method of claim 1, wherein the determining the transmission current consumption relationship comprises determining a hysteresis parameter for satisfying a performance increase threshold.

11. The method of claim 1, further comprising:
determining throughput requirements associated with an uplink data transmission based at least in part on an application executed by the UE.

12. A method of wireless communications by a user equipment (UE), comprising:
determining a first transmit power level associated with a first component carrier of a plurality of component carriers, the first component carrier being an anchor carrier for the plurality of component carriers in a downlink carrier aggregation mode;
estimating a second transmit power level associated with a second component carrier of the plurality of component carriers;
determining, based at least in part on the first transmit power level and the second transmit power level, a transmission current consumption relationship in the downlink carrier aggregation mode;
determining, based at least in part on the determining the transmission current consumption relationship, to switch the anchor carrier from the first component carrier to the second component carrier in the downlink carrier aggregation mode; and
modifying a measurement report, based at least in part on the determining to switch the anchor carrier, to satisfy a condition for switching the anchor carrier from the first component carrier to the second component carrier in the downlink carrier aggregation mode.

13. The method of claim 12, wherein the modifying the measurement report, based at least in part on the determining to switch the anchor carrier, to satisfy a condition for switching the anchor carrier comprises modifying the measurement report, based at least in part on the determining to switch the anchor carrier, to interchange the first component carrier and the second component carrier in the downlink carrier aggregation mode.

14. The method of claim 12, wherein the modifying the measurement report comprises modifying an A5 measurement report such that a received power metric associated with one of the first component carrier or the second component carrier is altered.

15. The method of claim 12, further comprising:
transmitting the measurement report to a base station.

16. The method of claim 12, further comprising:
transmitting an indication that the measurement report has been modified to a base station.

17. The method of claim 12, wherein a carrier frequency band of the first component carrier is a Long Term Evolution-Advanced (LTE-A) radio frequency spectrum band.

18. The method of claim 12, wherein a carrier frequency band of the second component carrier is an unlicensed radio frequency spectrum band.

19. An apparatus for wireless communication, in a system comprising:
a processor;
memory in electronic communication with the processor; and
one or more instructions stored in the memory and operable, when executed by the processor, to cause the apparatus to:
determine a second component carrier of a plurality of component carriers in a downlink carrier aggregation mode satisfies throughput requirements associated with an uplink data transmission;
determine, based at least in part on the throughput requirements being satisfied, a first transmit power level associated with a first component carrier of the plurality of component carriers, the first component carrier being an anchor carrier for the plurality of component carriers in the downlink carrier aggregation mode;
estimate a second transmit power level associated with the second component carrier;
determine, based at least in part on the first transmit power level and the second transmit power level, a transmission current consumption relationship; and
determine, based at least in part on the transmission current consumption relationship, whether to switch the anchor carrier from the first component carrier to the second component carrier in the downlink carrier aggregation mode.

20. The apparatus of claim 20, wherein the one or more instructions are further executable by the processor to:
determine to switch the anchor carrier from the first component carrier to the second component carrier based at least in part on a bandwidth of the first component carrier being larger than a bandwidth of the second component carrier.
